(19) United States
(12) Patent Application Publication
(10) Pub. No.: US 2022/0164756 A1
(43) Pub. Date: May 26, 2022

(54) PROCESS MANAGEMENT DEVICE AND MACHINE LEARNING DEVICE

(71) Applicant: Mitsubishi Electric Corporation, Tokyo (JP)

(72) Inventor: Takafumi Saihara, Tokyo (JP)

(73) Assignee: Mitsubishi Electric Corporation, Tokyo (JP)

(21) Appl. No.: 17/602,283

(22) PCT Filed: Mar. 26, 2020
(86) PCT No.: PCT/JP2020/013722

§ 371 Date: Oct. 8, 2021

(30) Foreign Application Priority Data
May 8, 2019 (JP) PCT/JP2019/018439

(51) Int. Cl. G06Q 10/06

(52) U.S. Cl. CPC G06Q 10/063114; G06Q 10/06312; G06Q 10/063118

(57) ABSTRACT

A process management device includes an event information management unit that checks a status of event occurrence in a subsequent step, the status of event occurrence being related to an event that affects a production ability of the subsequent step, the subsequent step being a later one of adjacent two steps. Further, there is a conveyance amount adjustment unit that adjusts, based on personal data and a result of checking by the event information management unit, distribution of intermediate products manufactured in a preceding step to workers who perform work of the subsequent step, the personal data indicating a production ability of each of the workers according to the status of event occurrence, the preceding step being an earlier one of the two adjacent steps.

### FIELD

The present invention relates to a process management device, a process management method, a process management program, and a machine learning device for managing a production process for products.

### BACKGROUND

In the recent manufacture of products in production facilities, it is common to manufacture products through a plurality of steps by allocating roles to the steps, rather than processing raw materials into products in one step. Such a production system generates processed members, i.e., intermediate products in the middle of production, every time an intermediate step is performed until the completion of products. In each step excluding the final step, generated processed members are conveyed to the next step.

The conveyance of processed members between steps may suffer from excess or deficiency, which is problematic because the involved steps become a bottleneck that affects the entire manufacturing activity and causes a decrease in production efficiency. A typical measure against this problem is to prepare a plurality of identical production environments for a time-consuming step for parallelization. In this case, however, intermediate products are produced in parallel, which makes it difficult to convey intermediate products to the next step without excess or deficiency. To deal with such a problem, methods for improving the efficiency of conveyance and minimizing bottlenecks have been proposed.

For example, Patent Literature 1 describes an invention related to the conveyance of workpieces between steps using an automatic guided vehicle. Specifically, the invention includes optimizing production efficiency by determining a work pattern based on the production variation rate of workpieces of various types and moving along a path that depends on the work pattern.

### CITATION LIST

### Patent Literature

Patent Literature 1: Japanese Patent Application Laid-open No. 2006-40125

### SUMMARY

### Technical Problem

In an actual production activity, events that affect production ability occur, such as a failure in a device introduced in each step constituting the production line, a fluctuation in production ability due to a change of a person in charge of work, and an improvement in production efficiency due to implementation of a measure for improving production efficiency. Therefore, when these events occur, it is necessary to perform adjustment such as changing the amount or path of conveyance of intermediate product in consideration of the place and extent of influence. In the invention described in Patent Literature 1, the path of workpiece conveyance is determined based on the standard work time, production variation rate, actual work time, and the like associated with each of different types of workpieces. Specifically, when the production variation rate exceeds a predetermined value, a path of conveyance for performing work in a work pattern that is not easily affected by fluctuations in the production variation rate is selected. However, the invention described in Patent Literature 1 is problematic in that when an event that affects production ability occurs in each step, an appropriate path of conveyance is not selected until the production variation rate actually changes due to the influence of the event, that is, there is a time lag from the occurrence of the event that affects production ability to switching to an appropriate path of conveyance, and the production efficiency is reduced until switching to an appropriate path of conveyance.

The present invention has been made in view of the above, and an object thereof is to obtain a process management device capable of improving the production efficiency of a product that is manufactured through a plurality of steps.

### Solution to Problem

In order to solve the above-described problems and achieve the object, a process management device according to the present invention includes a status checking unit that checks a status of event occurrence in a subsequent step, the status of event occurrence being related to an event that affects a production ability of the subsequent step, the subsequent step being a later one of adjacent two steps. The process management device also includes a distribution adjustment unit that adjusts, based on personal data and a result of checking by the status checking unit, distribution of intermediate products manufactured in a preceding step to workers who perform work of the subsequent step, the personal data indicating a production ability of each of the workers according to the status of event occurrence, the preceding step being an earlier one of the two adjacent steps.

### Advantageous Effects of Invention

The process management device according to the present invention can achieve the effect of improving the production efficiency of a product that is manufactured through a plurality of steps.

### BRIEF DESCRIPTION OF DRAWINGS

FIG. 1 is a diagram illustrating an exemplary configuration of a production system including a process management device according to a first embodiment of the present invention.

FIG. 2 is a diagram illustrating an example of hardware that implements the process management device according to the first embodiment.

FIG. 3 is a diagram illustrating an exemplary functional block configuration of a data processing unit included in the process management device according to the first embodiment.

FIG. 4 is a diagram illustrating an exemplary functional block configuration of a device information collecting device according to the first embodiment.

FIG. 5 is a diagram illustrating an exemplary configuration of a data holding unit included in the process management device according to the first embodiment.

FIG. 6 is a diagram illustrating an exemplary configuration of personal data held by the data holding unit of the process management device according to the first embodiment.

FIG. 7 is a flowchart illustrating an example of the operation of the process management device according to the first embodiment.

FIG. 8 is a diagram illustrating an exemplary screen that is displayed on a display unit by the process management device according to the first embodiment.

FIG. 9 is a flowchart illustrating an example of an overall operation in which the process management device adjusts the path and amount of conveyance of intermediate product according to the first embodiment.

FIG. 10 is a flowchart illustrating an example of the operation of the process management device and the device information collecting device according to the first embodiment.

FIG. 11 is a flowchart illustrating an example of how the process management device adjusts the amount of conveyance of intermediate product between steps according to the first embodiment.

FIG. 12 is a flowchart illustrating an example of how the process management device acquires and stores information on an event that occurs in the production process according to the first embodiment.

FIG. 13 is a flowchart illustrating an example of the operation of searching for an event in the data holding unit of the process management device according to the first embodiment.

FIG. 14 is a flowchart illustrating an example of how the process management device searches for personal data according to the first embodiment.

FIG. 15 is a flowchart illustrating an example of how the process management device checks a new event registration according to the first embodiment.

FIG. 16 is a diagram illustrating an exemplary event registration screen that is displayed by the display unit of the process management device according to the first embodiment.

FIG. 17 is a flowchart illustrating an example of how the process management device checks a new worker registration according to the first embodiment.

FIG. 18 is a diagram illustrating an exemplary worker registration screen that is displayed by the display unit of the process management device according to the first embodiment.

FIG. 19 is a flowchart illustrating an example of how the process management device updates personal data according to the first embodiment.

FIG. 20 is a flowchart illustrating an example of how the process management device checks whether it is necessary to change the allocation of workers in charge of the production process according to the first embodiment.

FIG. 21 is a flowchart illustrating an example of how the process management device corrects the allocation of workers in charge of the production process according to the first embodiment.

FIG. 22 is a diagram illustrating an exemplary configuration of a production system including a process management device according to a second embodiment of the present invention.

FIG. 23 is a diagram illustrating an exemplary configuration of a machine learning device.

FIG. 24 is a flowchart illustrating an example of the operation of the process management device according to the second embodiment.

FIG. 25 is a flowchart illustrating how a data processing unit collects learning data according to the second embodiment.

FIG. 26 is a flowchart illustrating an example of learning processing by the machine learning device.

FIG. 27 is a flowchart illustrating an example of how the machine learning device calculates the total production amount of final product.

### DESCRIPTION OF EMBODIMENTS

Hereinafter, a process management device, a process management method, a process management program, and a machine learning device according to embodiments of the present invention will be described in detail with reference to the drawings. The present invention is not limited to the embodiments.

### First Embodiment

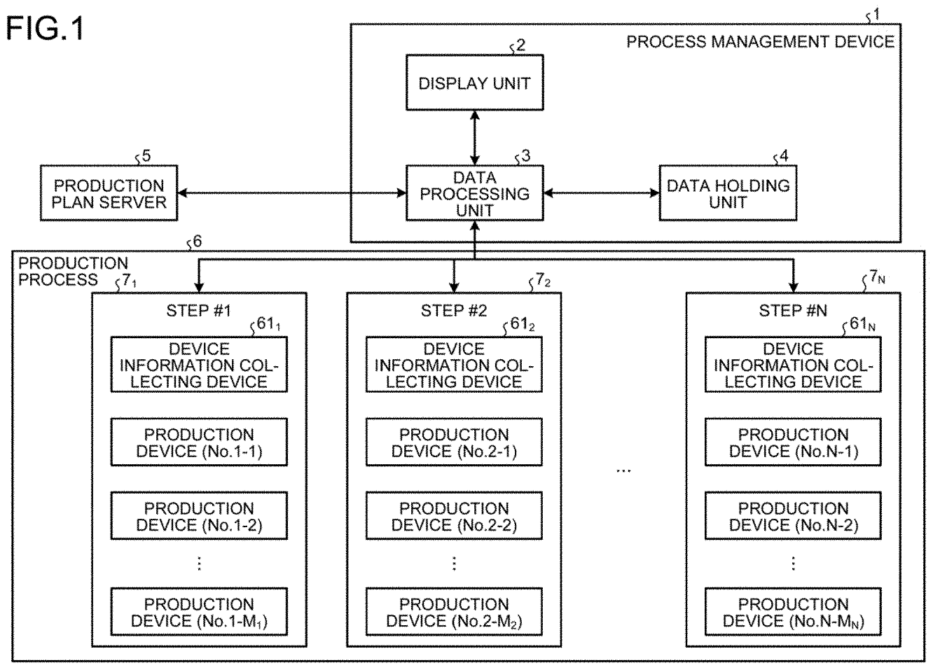

FIG. 1 is a diagram illustrating an exemplary configuration of a production system including a process management device according to a first embodiment of the present invention. The production system illustrated in FIG. 1 includes a process management device 1, a production plan server 5, and a production process 6. The production process 6 includes a plurality of steps: steps 7₁ to 7_{N}. In the following description, the steps 7₁ to 7_{N} may be referred to as steps #1 to #N for convenience. N is an integer of two or more. In the production process 6, work is performed in the order of step #1, step #2, . . . , and step #N to complete one product.

The process management device 1 includes a display unit 2, a data processing unit 3, and a data holding unit 4. The display unit 2 displays a production state and the like in each step constituting the production process 6. The data processing unit 3 determines, based on information acquired from the production process 6 and the production plan server 5, the path and amount of conveyance of intermediate product manufactured in each step excluding step #N of the production process 6. The data holding unit 4 holds various types of information and data acquired from the production process 6 and the production plan server 5. Data held by the data holding unit 4 include personal data of workers in charge of product manufacturing work in the production process 6. Personal data indicate the production ability of persons in charge of work in each step of the production process 6. Details of personal data will be described later.

The process management device 1 determines a production state in each step based on information obtained from each step constituting the production process 6, and adjusts the amount and path of conveyance of intermediate product between adjacent steps in consideration of the production state.

The production plan server 5 holds production plan information for products to be produced in each of the production process 6 and other production processes (not illustrated).

In each step 7ₙ (n=1, 2, 3, . . . , or N) constituting the production process 6, one or more production devices and a device information collecting device 61ₙ that collects information from each production device in the step are installed. Note that the device information collecting devices 61₁ to 61_{N} installed in the corresponding steps are identical. In the following description, in a case where it is not necessary to distinguish the device information collecting devices 61₁ to 61_{N}, they are collectively referred to as the device information collecting device 61.

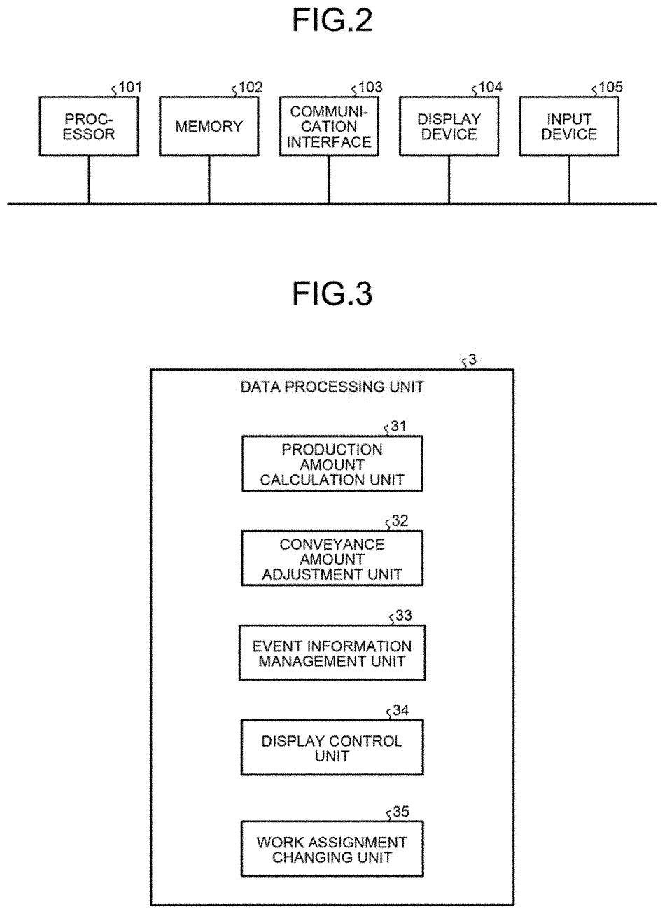

Here, a hardware configuration of the process management device 1 according to the present embodiment will be described. FIG. 2 is a diagram illustrating an example of hardware that implements the process management device 1 according to the first embodiment. The process management device 1 can be implemented by a processor 101, a memory 102, a communication interface 103, a display device 104, and an input device 105 illustrated in FIG. 2.

The processor 101 is a central processing unit (CPU, also referred to as a central processing device, a processing device, a computation device, a microprocessor, a microcomputer, or a digital signal processor (DSP)), a system large scale integration (LSI), or the like. The memory 102 is a random access memory (RAM), a read only memory (ROM), an erasable programmable read only memory (EPROM), an electrically erasable programmable read only memory (EEPROM, registered trademark), a hard disk drive, or the like. The communication interface 103 is a network interface card or the like. The display device 104 is a liquid crystal monitor, a display, or the like. The input device 105 is a mouse, a keyboard, a touch panel, or the like.

The data processing unit 3 of the process management device 1 is implemented by the processor 101 executing a program for operating as the data processing unit 3. The program for operating as the data processing unit 3 is stored in advance in the memory 102. The processor 101 operates as the data processing unit 3 by reading the program for operating as the data processing unit 3 from the memory 102 and executing the program.

Note that the program for operating as the data processing unit 3 may not necessarily be stored in advance in the memory 102. The above program may be written in a recording medium such as a compact disc (CD)-ROM or a digital versatile disc (DVD)-ROM for supply to the user so as to be installed in the memory 102 by the user. In this case, the hardware implementing the process management device 1 further includes a reading device for reading a program from a recording medium or an interface circuit for connecting a reading device. The program for operating as the data processing unit 3 may be downloaded via the Internet or the like.

The display unit 2 of the process management device 1 is implemented by the display device 104. The data holding unit 4 is implemented by the memory 102.

Note that the device information collecting device 61 installed in each step of the production process 6 can also be implemented by hardware similar to the hardware illustrated in FIG. 2.

FIG. 3 is a diagram illustrating an exemplary functional block configuration of the data processing unit 3 included in the process management device 1 according to the first embodiment.

The data processing unit 3 includes a production amount calculation unit 31, a conveyance amount adjustment unit 32, an event information management unit 33, a display control unit 34, and a work assignment changing unit 35.

The production amount calculation unit 31 calculates, for each worker, the production amount of product manufactured in each step of the production process 6 or of intermediate product in the middle of production. The term “production amount” as used herein means a production amount per predetermined unit time, that is, the production ability of each worker. Hereinafter, products manufactured in the final step of the production process 6 are also referred to as intermediate products for convenience of explanation.

Based on the production ability of each worker in the production process 6, the situation of each worker, the state of the production device that is used by each worker, and the like, the conveyance amount adjustment unit 32 adjusts the path and amount of conveyance of intermediate product manufactured in each step of the production process 6 to the next step. The amount of conveyance is the number of intermediate products that are conveyed on each path of conveyance per predetermined unit time.

The event information management unit 33 monitors the status of event occurrence for each production device, and manages information indicating the status of event occurrence. An event is an issue that affects production ability, such as stop or failure of a production device used in each step of the production process 6 or change of a worker.

The display control unit 34 performs control to cause the display unit 2 to display a screen for notifying the user of the process management device 1 of information, a screen for receiving an operation by the user, and the like.

The work assignment changing unit 35 changes the allocation of persons in charge of work to each step of the production process 6 in the event that the number of products that are manufactured in the production process 6 cannot achieve the production plan.

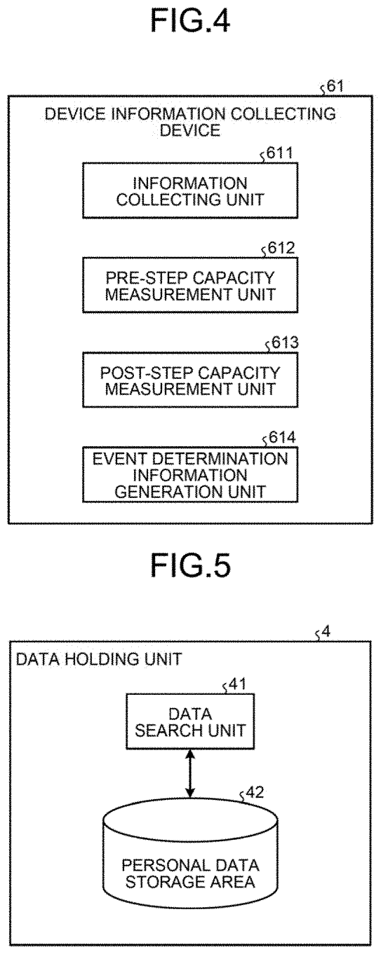

FIG. 4 is a diagram illustrating an exemplary functional block configuration of the device information collecting device 61 according to the first embodiment.

The device information collecting device 61 installed in each step of the production process 6 includes an information collecting unit 611, a pre-step capacity measurement unit 612, a post-step capacity measurement unit 613, and an event determination information generation unit 614.

The information collecting unit 611 gathers various types of information created by the pre-step capacity measurement unit 612, the post-step capacity measurement unit 613, and the event determination information generation unit 614, and transmits the information to the data processing unit 3 of the process management device 1.

The pre-step capacity measurement unit 612 measures a pre-step capacity indicating how many intermediate products are present in an intermediate product yard for each production device, the intermediate product yard being located before each production device in the step where the device information collecting device 61 is installed. Hereinafter, an intermediate product yard located before a production device is referred to as a pre-step processed member yard. Intermediate products in a pre-step processed member yard are intermediate products manufactured in the previous step, waiting to be processed or otherwise treated by the production device. The pre-step capacity is, for example, the use rate of the pre-step processed member yard. The pre-step capacity measurement unit 612 monitors the intermediate products carried in and out using, for example, cameras, sensors, and the like installed at the carry-in entrance and carry-out exit for intermediate products in the pre-step processed member yard, and obtains the pre-step capacity based on the number of intermediate products carried in and out and information on the size of the pre-step processed member yard (the number of intermediate products that can be placed in the pre-step processed member yard).

The post-step capacity measurement unit 613 measures a post-step capacity indicating how many intermediate products are present in an intermediate product yard for each production device, the intermediate product yard being located after each production device in the step where the device information collecting device 61 is installed. Hereinafter, an intermediate product yard located after a production device is referred to as a post-step processed member yard. The post-step capacity is, for example, the use rate of the post-step processed member yard. The post-step capacity measurement unit 613 obtains the post-step capacity in a similar manner to the way the pre-step capacity measurement unit 612 obtains the pre-step capacity.

The event determination information generation unit 614 generates information for use by the process management device 1 to determine the status of event occurrence in the step where the device information collecting device 61 is installed. For example, the event determination information generation unit 614 acquires information indicating the operation state of production devices from programmable logic controllers (PLCs) that are control devices for controlling the production devices, thereby generating event determination information for use by the process management device 1 to determine the status of event occurrence.

FIG. 5 is a diagram illustrating an exemplary configuration of the data holding unit 4 included in the process management device 1 according to the first embodiment. As illustrated in FIG. 5, the data holding unit 4 includes a data search unit 41 and a personal data storage area 42.

The data search unit 41 searches the personal data stored in the personal data storage area 42 for personal data of the worker specified by the data processing unit 3.

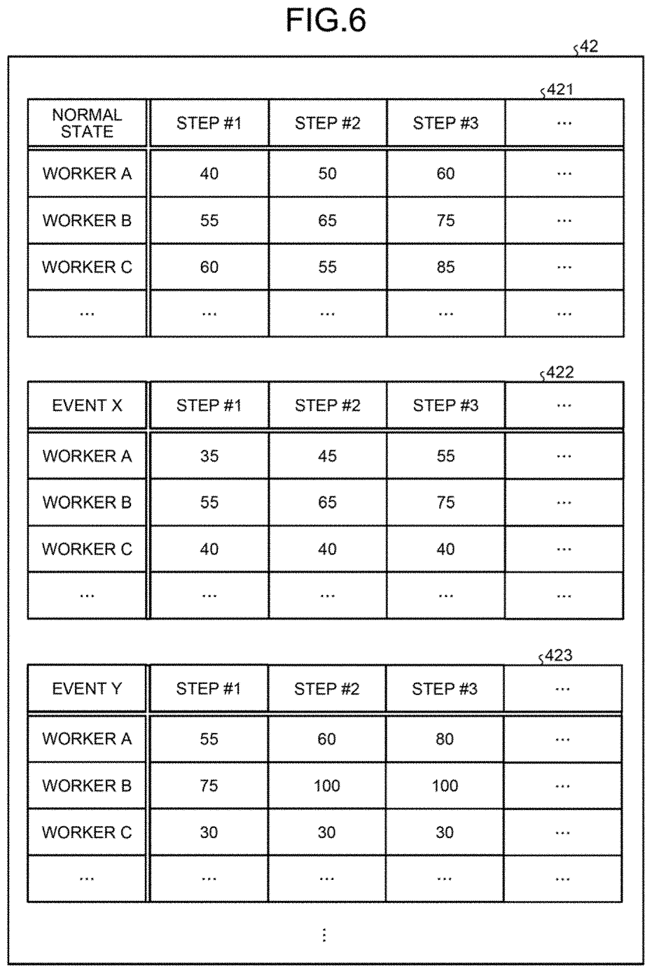

The personal data storage area 42 stores personal data of workers in charge of product manufacturing work in the production process 6. Personal data of workers are, for example, data having the configuration illustrated in FIG. 6.

FIG. 6 is a diagram illustrating an exemplary configuration of personal data held by the data holding unit 4 of the process management device 1 according to the first embodiment.

As illustrated in FIG. 6, the personal data storage area 42 of the data holding unit 4 holds data tables 421, 422, 423, etc. in which personal data are registered.

In the data table 421, the production ability of each worker in a normal state free from events, namely issues that affect production ability, is registered for each step. For example, the production ability of the worker A to perform the work of step #1 in the normal state is “40”. The numerical value “40” indicates the number of intermediate products that can be manufactured within a predetermined period of time. Therefore, in the case that the workers A to C perform the work of step #1 in the normal state, the production ability of the worker C is the highest, and the production ability of the worker B is the second highest. The production ability of the worker A is the lowest. In the case that the workers A to C perform the work of step #2 in the normal state, the production ability of the worker B is the highest.

Similarly, in the data table 422, the production ability of each worker during the occurrence of an event X is registered for each step. In the data table 423, the production ability of each worker during the occurrence of an event Y is registered for each step.

As illustrated in FIG. 6, the production ability of each worker varies according to the state of event occurrence. The production ability of each worker also varies depending on which step the worker performs.

Although not illustrated in FIG. 5, the data holding unit 4 includes a storage area for storing data other than personal data, in addition to the personal data storage area 42.

Next, an outline of the operation of the process management device 1, specifically, the operation of adjusting the path and amount of conveyance of intermediate product between adjacent steps of the production process 6, will be described.

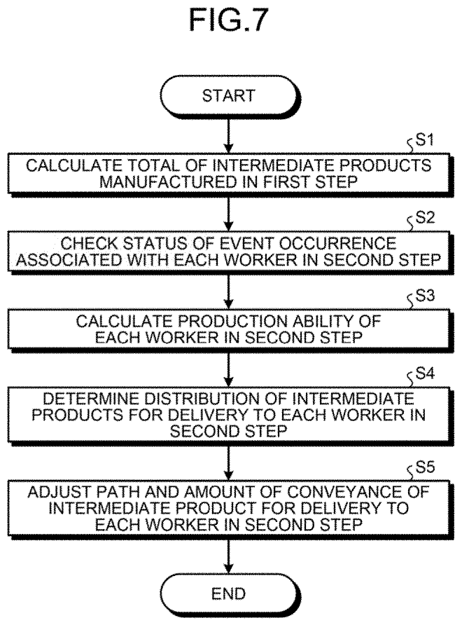

FIG. 7 is a flowchart illustrating an example of the operation of the process management device 1 according to the first embodiment. The process management device 1 repeatedly performs the operation illustrated in the flowchart of FIG. 7 at regular intervals to periodically adjust the path and amount of conveyance of intermediate product between adjacent steps of the production process 6. Note that the process management device 1 performs the operation illustrated in the flowchart of FIG. 7 for all combinations of two adjacent steps of the production process 6. For example, in a case where the production process 6 includes steps #1 to #4, the operation illustrated in the flowchart of FIG. 7 is executed for each of the combination of step #1 and step #2, the combination of step #2 and step #3, and the combination of step #3 and step #4.

In order to adjust the path and amount of conveyance of intermediate product between adjacent steps, the process management device 1 first calculates the total of intermediate products manufactured in the first step, i.e., the earlier one of the two adjacent steps (step S1). The term “total” as used herein is the total number of intermediate products manufactured by each production device in the first step during the period from the previous execution of the operation illustrated in the flowchart of FIG. 7 to the present. For example, in a case where the operation illustrated in the flowchart of FIG. 7 is set to be performed every five minutes, the process management device 1 calculates in step S1 the total number of intermediate products manufactured by each production device in the first step in the past five minutes. The process management device 1 acquires necessary information from the device information collecting device 61 in the first step, and performs calculation processing in step S1. For example, the process management device 1 calculates the total of intermediate products manufactured in the first step using the pre-step capacity and post-step capacity described above. In a case where the number of manufactured intermediate products is managed by the device information collecting device 61, the process management device 1 may acquire information on the number of manufactured intermediate products. Note that in the process management device 1, the production amount calculation unit 31 of the data processing unit 3 performs step S1.

Next, the process management device 1 checks the status of event occurrence associated with each worker in the step subsequent to the first step, or the second step, i.e., the later one of the two adjacent steps (step S2). Events associated with each worker include events related to the worker and events related to the production device that is used by the worker. An event related to the worker is an event that causes a change in production ability due to the worker, such as a change of the worker, for example. An event related to the production device that is used by the worker is an event that causes a change in production ability due to the production device, such as a failure in the production device, for example. Note that these events associated with each worker are non-limiting examples. Events associated with each worker can be various issues that affect production ability, e.g., the elapsed time from the start of operation of the production line reaching a certain value. The process management device 1 acquires a result of detection by the event determination information generation unit 614 from the device information collecting device 61 in the second step, and checks the status of event occurrence associated with each worker in the second step. Note that in the process management device 1, the event information management unit 33 of the data processing unit 3 performs step S2. The event information management unit 33 of the data processing unit 3 operates as a status checking unit that checks a status of event occurrence in a subsequent step, the status of event occurrence being related to an event that affects a production ability of the subsequent step, the subsequent step being a later one of adjacent two steps.

Next, the process management device 1 calculates the production ability of each worker in the second step (step S3). The process management device 1 calculates the production ability of each worker based on the result of checking in step S2, that is, the status of event occurrence associated with each worker in the second step, and the personal data held by the data holding unit 4. Note that in the process management device 1, the conveyance amount adjustment unit 32 of the data processing unit 3 performs step S3.

Next, the process management device 1 determines the distribution of intermediate products for delivery to each worker in the second step (step S4). The process management device 1 determines the distribution of intermediate products for delivery to each worker in the second step based on the production ability of each worker in the second step calculated in step S3. That is, the process management device 1 determines the distribution of intermediate products such that more intermediate products manufactured in the first step are delivered to workers with higher production ability. At this time, the process management device 1 may determine the distribution in consideration of the pre-step capacity of the production device used by each worker in the second step, that is, the use rate of the pre-step processed member yard described above. For example, in a case where the use rate of the pre-step processed member yard of the production device used by a certain worker is higher than that for other workers, the distribution of intermediate products for delivery to this worker may be lowered so that the pre-step processed member yards have a uniform use rate among the workers. For example, the process management device 1 compares the use rate of each of a plurality of pre-step processed member yards with an average use rate, and determines that the use rate of a pre-step processed member yard is higher than that for other workers in a case where the difference from the average use rate is greater than or equal to a predetermined threshold. Note that in the process management device 1, the conveyance amount adjustment unit 32 of the data processing unit 3 performs step S4.

Next, the process management device 1 adjusts the path and amount of conveyance of intermediate product for delivery to each worker in the second step (step S5). The process management device 1 adjusts the path and amount of conveyance such that the intermediate products manufactured in the first step are delivered to the workers in the second step according to the distribution determined in step S4. Note that the process management device 1 may adjust only the amount of conveyance. The process management device 1 may determine that it is not necessary to adjust the path and amount of conveyance, in which case the process management device 1 does not perform adjustment. The path of conveyance is adjusted or changed by adjusting the amount of conveyance. Specifically, the path of conveyance of intermediate product is adjusted by setting the amount of conveyance of intermediate product to a certain worker to zero (0) or setting the amount of conveyance of intermediate product to a worker whose amount of conveyance has been zero to a value different from zero. That is, the adjustment of the path of conveyance is one form of adjustment of the amount of conveyance. In the process management device 1, the conveyance amount adjustment unit 32 of the data processing unit 3 performs step S5. The conveyance amount adjustment unit 32 instructs a conveyance device that conveys intermediate products from the step corresponding to the first step to the step corresponding to the second step, among conveyance devices (not illustrated in FIG. 1), to adjust the path and amount of conveyance.

The conveyance amount adjustment unit 32 of the data processing unit 3 is a distribution adjustment unit that adjusts, based on personal data and the status of event occurrence in the subsequent step, distribution of intermediate products manufactured in a preceding step to workers who perform work of the subsequent step, the personal data indicating a production ability of each of the workers according to the status of event occurrence.

Note that the conveyance amount adjustment unit 32, which is the distribution adjustment unit of the process management device 1, may determine the distribution using machine learning, instead of calculating in step S3 the production ability of each worker in the second step and determining in step S4 the distribution of intermediate products for delivery to each worker in the second step based on the production ability calculated in step S3.

In the case of determining the distribution using machine learning, the conveyance amount adjustment unit 32 executes a first process of observing, as state variables, the status of event occurrence associated with each worker in the second step and the personal data held by the data holding unit 4, a second process of creating a training data set based on the state variables observed in the first process and the use rate of each of the pre-step processed member yards provided before the production devices in the second step, and a third process of learning the distribution of intermediate products for delivery to each worker in the second step according to the training data set created in the second process. The conveyance amount adjustment unit 32 executes the first process, the second process, and the third process every time the conveyance amount adjustment unit 32 executes step S5 described above. Note that in the second process, a training data set is created using the use rate of each pre-step processed member yard at the point of time when a predetermined period of time has elapsed since the execution of step S5. When determining the distribution of intermediate products for delivery to each worker in the second step, the conveyance amount adjustment unit 32 determines the distribution based on the status of event occurrence associated with each worker in the second step at that point of time, the personal data held by the data holding unit 4, and the result of learning obtained by executing the first step, the second step, and the third process.

The conveyance amount adjustment unit 32 may perform the above learning using any type of machine learning. For example, reinforcement learning can be used. In reinforcement learning, an agent (subject of an action) in an environment observes the current state and determines the action to take. The agent gains a reward from the environment by selecting an action, and learns how to maximize the reward through a series of actions. In the case that the conveyance amount adjustment unit 32 uses reinforcement learning, the current state to be observed is the status of event occurrence associated with each worker in the second step and personal data. The action to take is the determination of distribution. The conveyance amount adjustment unit 32 learns the distribution of intermediate products for delivery to each worker in the second step such that the use rate of each of the pre-step processed member yards provided before the production devices in the second step approaches the same value, that is, becomes substantially uniform.

Q-learning, TD-learning, or the like is known as a representative method of reinforcement learning. Because these methods are well known, detailed description thereof will be omitted. In the case of using Q-learning, the conveyance amount adjustment unit 32 determines the distribution as the action to take using an action value function. In addition, the conveyance amount adjustment unit 32 updates the action value function as needed using the training data set described above. Specifically, the conveyance amount adjustment unit 32 calculates a reward based on the training data set and updates the action value function according to the calculated reward, thereby learning the distribution of intermediate products for delivery to each worker in the second step. In the calculation of the reward, for example, the conveyance amount adjustment unit 32 compares the use rate of each pre-step processed member yard with an average use rate, increases the reward in a case where the difference between the use rate and the average use rate is less than a predetermined threshold (for example, gives a reward of “1”), and reduces the reward in a case where the difference between the use rate and the average use rate is greater than or equal to the threshold (for example, gives a reward of “−1”).

In association with the operation described with reference to FIG. 7, that is, the operation of adjusting the path and amount of conveyance of intermediate product between adjacent steps of the production process 6, the process management device 1 has a function of displaying how the adjustment is actually performed on the display unit 2 to notify the user.

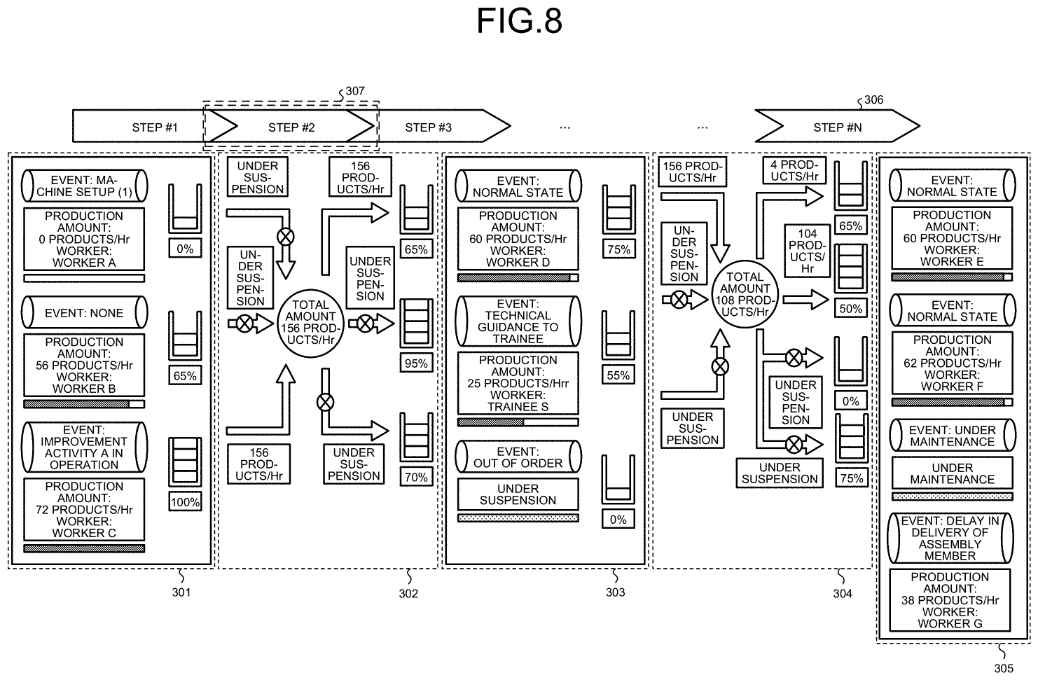

FIG. 8 is a diagram illustrating an exemplary screen that is displayed on the display unit 2 by the process management device 1 according to the first embodiment. Specifically, FIG. 8 illustrates an example of a screen that displays the result of adjustment of the path and amount of conveyance of intermediate product by the process management device 1.

As illustrated in FIG. 8, the process management device 1 displays, for each device in a certain step, the current status of events, the production ability (production amount), the person in charge of work, and the occupancy of the processed member capacities before and after the device (corresponding to the pre-step capacity and post-step capacity described above) (301, 303, and 305). In addition, the process management device 1 displays, between steps, the amount of movement of processed member per unit time (xx/Hr) to each device in the subsequent step (302 and 304). In addition, the process management device 1 displays, in the upper part of the screen, information 306 on the entire process and information 307 indicating which part is currently displayed so that the step that is currently displayed can be recognized.

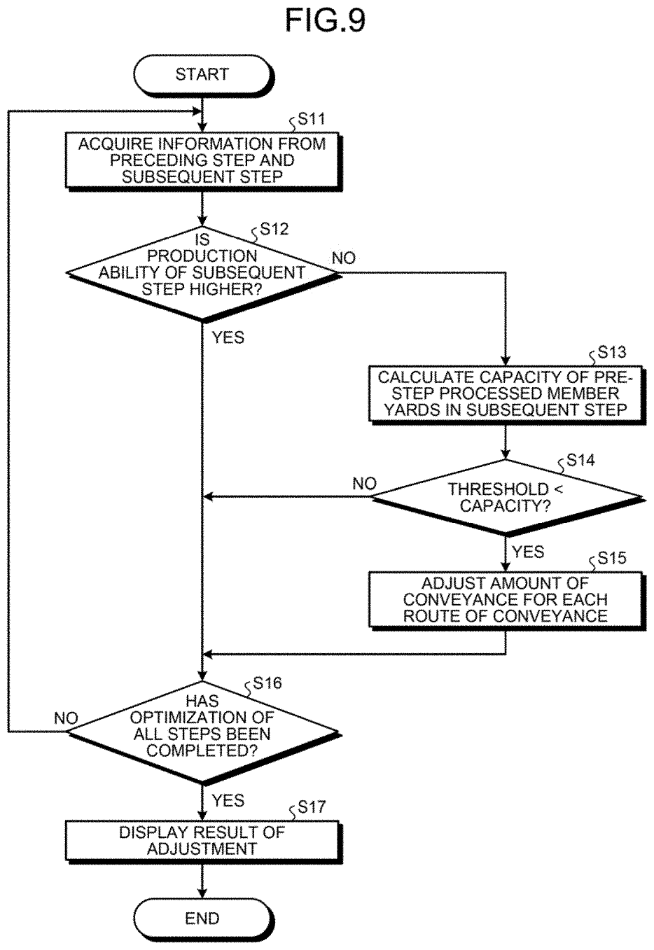

Next, the operation of the process management device 1 will be described in detail. First, the operation of adjusting the path and amount of conveyance of intermediate product, which has been outlined with reference to FIG. 7, will be described in detail with reference to FIGS. 9 to 11.

FIG. 9 is a flowchart illustrating an example of an overall operation in which the process management device 1 adjusts the path and amount of conveyance of intermediate product according to the first embodiment.

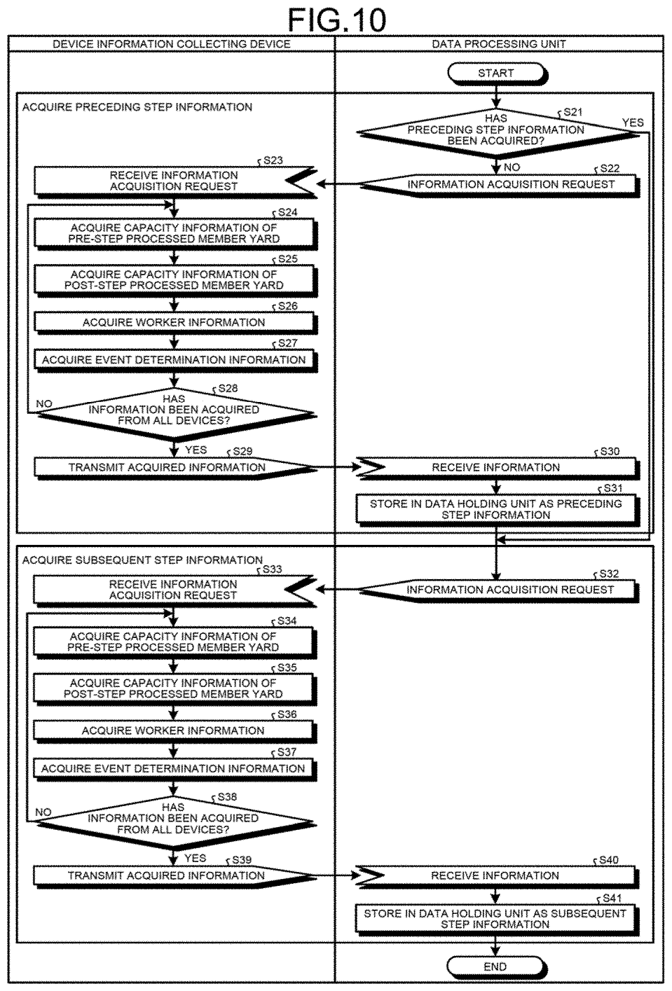

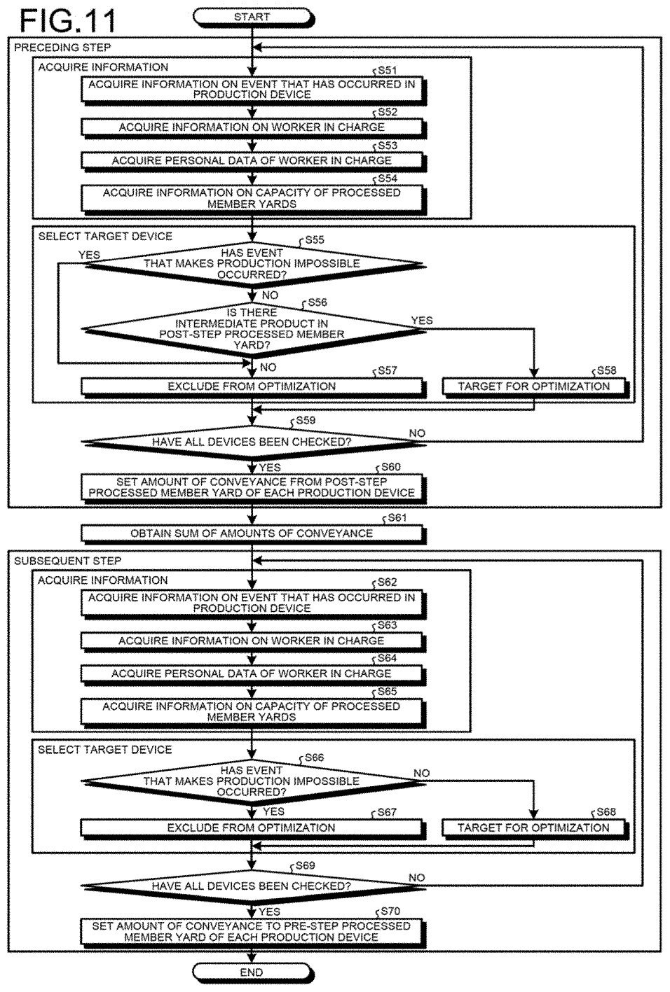

First, the process management device 1 selects two adjacent steps as the steps to be adjusted from among a plurality of steps included in the production process 6, and acquires information from the two steps to be adjusted: the preceding step and the subsequent step (step S11). Information that is acquired by the process management device 1 in step S11 is information necessary for adjusting the path and amount of conveyance of intermediate product from the preceding step to the subsequent step. The process management device 1 acquires information from the preceding step and the subsequent step according to the sequence illustrated in FIG. 10.

FIG. 10 is a flowchart illustrating an example of the operation of the process management device 1 and the device information collecting device 61 according to the first embodiment. The flowchart of FIG. 10 indicates an example of how the process management device 1 acquires information from the device information collecting device 61 for use in adjusting the path and amount of conveyance of intermediate product. In the following description, information that is acquired from the preceding step may be referred to as “preceding step information”. Similarly, information that is acquired from the subsequent step may be referred to as “subsequent step information”.

In step S11 of FIG. 9, the data processing unit 3 of the process management device 1 executes steps S21 to S31 in FIG. 10 to acquire information from the preceding step which is the first step, and executes steps S32 to S41 to acquire information from the subsequent step which is the second step.

As illustrated in FIG. 10, the data processing unit 3 checks whether preceding step information has been acquired (step S21), and when preceding step information has been acquired (step S21: Yes), the data processing unit 3 proceeds to step S32 to start acquiring subsequent step information.

When preceding step information has not been acquired (step S21: No), the data processing unit 3 transmits an information acquisition request to the device information collecting device 61 installed in the preceding step (hereinafter referred to as the device information collecting device 61 in the preceding step) (step S22).

Upon receiving the information acquisition request (step S23), the device information collecting device 61 in the preceding step acquires, from one of the production devices in the preceding step, capacity information of the pre-step processed member yard, capacity information of the post-step processed member yard, worker information, and event determination information (steps S24, S25, S26, and S27). The capacity information of the pre-step processed member yard is the pre-step capacity described above, and the capacity information of the post-step processed member yard is the post-step capacity described above. The worker information is identification information of the worker which is information unique to the worker, such as the name of the worker and the worker identification number assigned to the worker in advance. The event determination information is information that the data processing unit 3 uses for determining whether an event that affects production ability has occurred in the production device and the worker using the production device in the preceding step, and for determining the type of the event that has occurred. The event determination information includes one or more pieces of information. An example of information included in the event determination information is information on the operating state of the production device.

Upon executing steps S24 to S27, the device information collecting device 61 in the preceding step next checks whether information has been acquired from all the devices, that is, whether steps S24 to S27 have been executed for all the production devices in the preceding step (step S28), and when information has not been acquired from one or more production devices (step S28: No), the device information collecting device 61 in the preceding step executes steps S24 to S27 for one of the production devices from which information has not been acquired. When information has been acquired from all the devices (step S28: Yes), the device information collecting device 61 in the preceding step transmits the information acquired from each production device in the preceding step to the data processing unit 3 (step S29).

Upon receiving the information from the device information collecting device 61 in the preceding step (step S30), the data processing unit 3 stores the received information in the data holding unit 4 as preceding step information (step S31).

Next, the data processing unit 3 transmits an information acquisition request to the device information collecting device 61 installed in the subsequent step (hereinafter referred to as the device information collecting device 61 in the subsequent step) (step S32).

Upon receiving the information acquisition request (step S33), the device information collecting device 61 in the subsequent step executes steps S34 to S39. Because steps S34 to S39 are similar to steps S24 to S29 described above, the description thereof will be omitted.

Upon receiving the information from the device information collecting device 61 in the subsequent step (step S40), the data processing unit 3 stores the received information in the data holding unit 4 as subsequent step information (step S41).

Returning to FIG. 9, after executing step S11, the process management device 1 calculates the production ability of the preceding step and the production ability of the subsequent step from the preceding step information and the subsequent step information acquired in step S11, and checks whether the production ability of the subsequent step is higher than the production ability of the preceding step (step S12). When the production ability of the subsequent step is higher (step S12: Yes), the process management device 1 determines that it is unnecessary to adjust the route and amount of conveyance of intermediate product from the preceding step to the subsequent step of the two steps to be adjusted. Then, the process management device 1 checks whether the optimization of all the steps has been completed, that is, whether the route and amount of conveyance of intermediate product from the preceding step to the subsequent step have been adjusted for all the combinations of two adjacent steps of the plurality of steps included in the production process 6 (step S16).

When there is a step that has not been optimized (step S16: No), the process management device 1 returns to step S11 and continues the operation.

When the optimization of all the steps has been completed (step S16: Yes), the process management device 1 displays the result of adjustment on the display unit 2 (step S17). In this step S17, the process management device 1 displays a screen such as the one illustrated in FIG. 8 on the display unit 2.

On the other hand, when the production ability of the subsequent step is lower than or equal to the production ability of the preceding step (step S12: No), the process management device 1 calculates the capacity of the pre-step processed member yards in the subsequent step using the subsequent step information acquired in step S11 (step S13). In this step S13, the process management device 1 calculates the above-described pre-step capacity for each production device in the subsequent step, and obtains the sum of the pre-step capacities of the production devices for use as the capacity of the pre-step processed member yards in the subsequent step.

Next, the process management device 1 compares the capacity of the pre-step processed member yards in the subsequent step calculated in step S13 with a predetermined threshold (step S14), and in response to determining that the capacity of the pre-step processed member yards in the subsequent step is less than or equal to the threshold (step S14: No), proceeds to step S16.

On the other hand, in response to determining that the capacity of the pre-step processed member yards in the subsequent step is greater than the threshold (step S14: Yes), the process management device 1 adjusts the amount of conveyance of intermediate product for each route of conveyance between the preceding step and the subsequent step (step S15). The process management device 1 adjusts the amount of conveyance of intermediate product for each route of conveyance between the preceding step and the subsequent step according to the flowchart illustrated in FIG. 11.

FIG. 11 is a flowchart illustrating an example of how the process management device 1 adjusts the amount of conveyance of intermediate product between steps according to the first embodiment.

In step S15 of FIG. 9, the data processing unit 3 of the process management device 1 executes steps S51 to S60 of FIG. 11 to adjust the amount of conveyance from the post-step processed member yard of each production device in the preceding step, and executes steps S61 to S70 to adjust the amount of conveyance to the pre-step processed member yard of each production device in the subsequent step.

As illustrated in FIG. 11, the data processing unit 3 acquires, for the preceding step, information on an event that has occurred in the production device, information on the worker in charge, personal data of the worker in charge, and information on the capacity of the processed member yards (steps S51, S52, S53, and S54). Note that in step S54, both the capacity of the pre-step processed member yard and the capacity of the post-step processed member yard are acquired. In addition, in a case where a plurality of production devices are installed in the preceding step, the data processing unit 3 selects one of the plurality of production devices, and executes steps S51 to S54 on the selected production device to acquire information of the above-described types. The data processing unit 3 acquires information of the above-described types from the data holding unit 4. That is, the data processing unit 3 extracts information of the above-described types on the selected production device from the preceding step information acquired in step S11 described above and stored in the data holding unit 4. However, information on an event that has occurred in the production device is acquired in step S51 by the data processing unit 3 determining the status of event occurrence using the event determination information extracted from the preceding step information. A method of acquiring information on an event that has occurred in the production device will be described later.

Next, the data processing unit 3 checks whether an event that makes production impossible has occurred in the production device corresponding to each piece of information acquired above (step S55), and when an event that makes production impossible has occurred (step S55: Yes), the data processing unit 3 excludes the production device from optimization (step S57).

When an event that makes production impossible has not occurred in the production device corresponding to each piece of information acquired above (step S55: No), the data processing unit 3 checks whether there is an intermediate product in the post-step processed member yard of the production device (step S56).

When there is no intermediate product in the post-step processed member yard (step S56: No), the data processing unit 3 excludes the production device corresponding to each piece of information acquired above from optimization (step S57). On the other hand, when there is an intermediate product in the post-step processed member yard (step S56: Yes), the production device corresponding to each piece of information acquired above is targeted for optimization (step S58).

Next, the data processing unit 3 checks whether check processing, which is the processing described in steps S51 to S58, has been completed for all the production devices in the preceding step (step S59), and when check processing has not been completed for one or more production devices (step S59: No), the data processing unit 3 executes steps S51 to S58 for one of the production devices for which check processing has not been completed.

When check processing has been completed for all the production devices in the preceding step (step S59: Yes), the data processing unit 3 sets the amount of conveyance from the post-step processed member yard of each production device in the preceding step (step S60). In step S60, the data processing unit 3 sets the amount of conveyance of intermediate product to the subsequent step from the post-step processed member yard of each production device to be optimized among the production devices in the preceding step. At this time, the data processing unit 3 sets the amount of conveyance from each of the post-step processed member yards such that the post-step processed member yards of the production devices to be optimized have a uniform capacity at the point of time when a predetermined period of time has elapsed.

Next, the data processing unit 3 obtains the sum of the amounts of conveyance of intermediate product from the preceding step to the subsequent step (step S61). In step S61, the data processing unit 3 obtains, based on the result of setting in step S60, the sum of the amounts of conveyance from the post-step processed member yards of the production devices to be optimized.

Next, the data processing unit 3 acquires, for the subsequent step, information on an event that has occurred in the production device, information on the worker in charge, personal data of the worker in charge, and information on the capacity of the processed member yards (steps S62, S63, S64, and S65). Note that in step S65, both the capacity of the pre-step processed member yard and the capacity of the post-step processed member yard are acquired. In addition, in a case where a plurality of production devices are installed in the subsequent step, the data processing unit 3 selects one of the plurality of production devices, and executes steps S62 to S65 on the selected production device to acquire information of the above-described types. The data processing unit 3 acquires information of the above-described types from the data holding unit 4. That is, the data processing unit 3 extracts information of the above-described types on the selected production device from the subsequent step information acquired in step S11 described above and stored in the data holding unit 4.

Next, the data processing unit 3 checks whether an event that makes production impossible has occurred in the production device corresponding to each piece of information acquired above (step S66), and when an event that makes production impossible has occurred (step S66: Yes), the data processing unit 3 excludes the production device from optimization (step S67).

When an event that makes production impossible has not occurred in the production device corresponding to each piece of information acquired above (step S66: No), the data processing unit 3 targets the production device for optimization (step S68).

Next, the data processing unit 3 checks whether check processing, which is the processing described in steps S62 to S68, has been completed for all the production devices in the subsequent step (step S69), and when check processing has not been completed for one or more production devices (step S69: No), the data processing unit 3 executes steps S62 to S68 for one of the production devices for which check processing has not been completed.

When check processing has been completed for all the production devices in the subsequent step (step S69: Yes), the data processing unit 3 sets the amount of conveyance to the pre-step processed member yard of each production device in the subsequent step (step S70). In step S70, the data processing unit 3 sets the amount of conveyance of intermediate product from the preceding step to the pre-step processed member yard for the production device to be optimized among the production devices in the subsequent step. At this time, the data processing unit 3 sets the amount of conveyance based on the sum of the amounts of conveyance obtained in step S61 described above and the personal data of each of the workers who use the production devices in the subsequent step to be optimized such that the pre-step processed member yards of the production devices in the subsequent step to be optimized have a uniform capacity at the point of time when a predetermined period of time has elapsed.

Returning to FIG. 9, once the conveyance amount adjustment described in step S15 is completed, the process management device 1 executes step S16.

The process management device 1 executes the operation represented by the flowchart illustrated in FIG. 9 for all combinations of two adjacent steps of the production process 6.

As described above, for conveyance amount adjustment, the process management device 1 adjusts the amount of conveyance of intermediate product from the post-step processed member yard of each production device in the preceding step to the pre-step processed member yard of each production device in the subsequent step based on information on the state of each production device and personal data of the workers in the preceding step to be adjusted and on information on the state of each production device and personal data of the workers in the subsequent step. In addition, the process management device 1 adjusts the amount of conveyance such that the post-step processed member yards of the production devices in the preceding step have a uniform capacity and the pre-step processed member yards of the production devices in the subsequent step have a uniform capacity. As a result, it is possible to prevent the occurrence of excess or deficiency of intermediate products before work is performed in each production device in the subsequent step, and it is possible to improve the production efficiency of the entire production process 6.

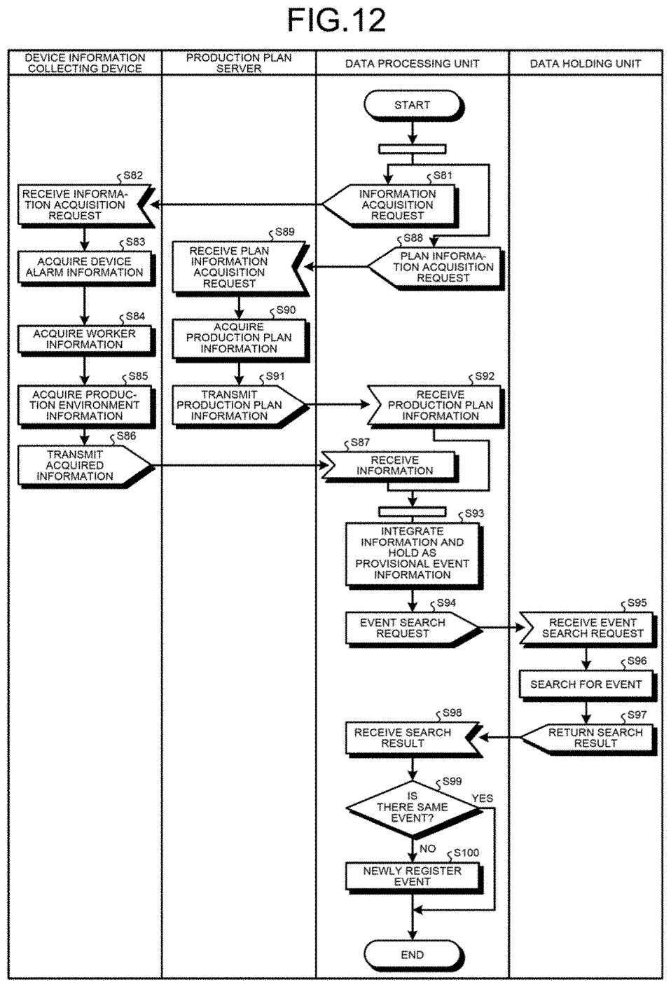

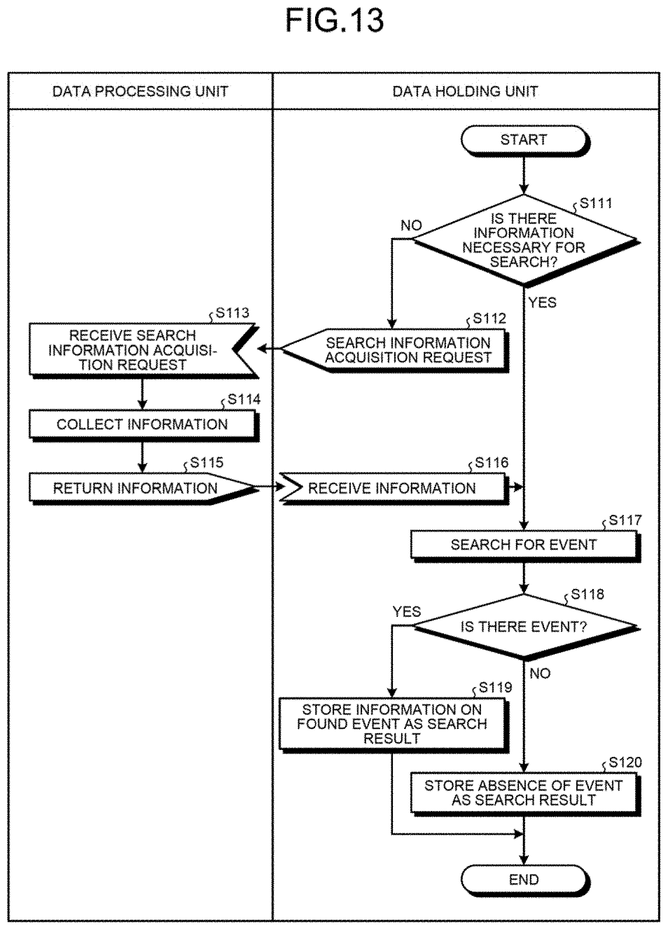

Next, a method for the process management device 1 to acquire and store information on an event that occurs in the production process 6 will be described with reference to FIGS. 12 and 13.

FIG. 12 is a flowchart illustrating an example of how the process management device 1 acquires and stores information on an event that occurs in the production process 6 according to the first embodiment.

In order for the process management device 1 to acquire information on an event that occurs in the production process 6, as illustrated in FIG. 12, the data processing unit 3 first transmits an information acquisition request to acquire necessary information from the device information collecting device 61 (step S81). At this time, the data processing unit 3 transmits an information acquisition request including information specifying one production device. Upon receiving the information acquisition request (step S82), the device information collecting device 61 acquires device alarm information, worker information, and production environment information from the specified production device (steps S83, S84, and S85). The device alarm information is information indicating the occurrence or non-occurrence of a failure in the device and details of a failure having occurred. The production environment information includes information such as the temperature and humidity of the place where the production facility is installed.

After executing steps S82 to S85, the device information collecting device 61 transmits the information acquired in each of these steps to the data processing unit 3 (step S86).

In addition, the data processing unit 3 transmits a plan information acquisition request to the production plan server 5 (step S88). Upon receiving the plan information acquisition request (step S89), the production plan server 5 acquires production plan information corresponding to the plan information acquisition request, and transmits the production plan information to the data processing unit 3 (steps S90 and S91).

Upon receiving the information from the device information collecting device 61 (step S87) and receiving the production plan information from the production plan server 5 (step S92), the data processing unit 3 integrates the received information, and holds the information obtained through the integration as provisional event information (step S93). Next, the data processing unit 3 transmits an event search request to the data holding unit 4 (step S94). The event search request includes the information obtained through the integration processing in step S93.

Upon receiving the event search request (step S95), the data holding unit 4 searches for an event (step S96). That is, the data holding unit 4 checks whether the held information contains information on an event including the same information as the information included in the received event search request.

The event search operation in step S96 will be described with reference to FIG. 13. FIG. 13 is a flowchart illustrating an example of the operation of searching for an event in the data holding unit 4 of the process management device 1 according to the first embodiment.

As illustrated in FIG. 13, the data holding unit 4 that has received the event search request checks whether there is information necessary for search, that is, whether information necessary for search is included in the event search request (step S111). When there is no necessary information (step S111: No), the data holding unit 4 transmits a search information acquisition request to the data processing unit 3 (step S112). Upon receiving the search information acquisition request (step S113), the data processing unit 3 collects information necessary for search (step S114), and returns the information to the data holding unit 4 (step S115).

Upon receiving the information necessary for search (step S116), the data holding unit 4 searches for an event using the received information (step S117).

In addition, when information necessary for search is included in the event search request (step S111: Yes), the data holding unit 4 searches for an event using the information included in the event search request (step S117).

In the presence of an event, that is, in response to finding a corresponding event through the search in step S117 (step S118: Yes), the data holding unit 4 stores information on the found event as a search result (step S119). Information on the found event is the name, identification information, or the like indicating the found event. On the other hand, in the absence of an event, that is, in response to not finding a corresponding event through the search in step S117 (step S118: No), the data holding unit 4 stores the absence of an event as a search result (step S120).

Returning to FIG. 12, after the event search, the data holding unit 4 returns the search result to the data processing unit 3 (step S97).

Upon receiving the search result from the data holding unit 4 (step S98), the data processing unit 3 checks whether there is the same event, that is, whether an event including the same information as the provisional event information held in step S93 has been found (step S99).

When there is the same event (step S99: Yes), the data processing unit 3 ends the operation. On the other hand, when there is not the same event (step S99: No), the data processing unit 3 newly registers an event (step S100), and ends the operation. In step S100, the data processing unit 3 causes the data holding unit 4 to store the held provisional event information as new event information.

The process management device 1 performs the operations illustrated in FIGS. 12 and 13 on all the production devices in all the steps constituting the production process 6, thereby acquiring and storing information on events that occur in the production process 6.

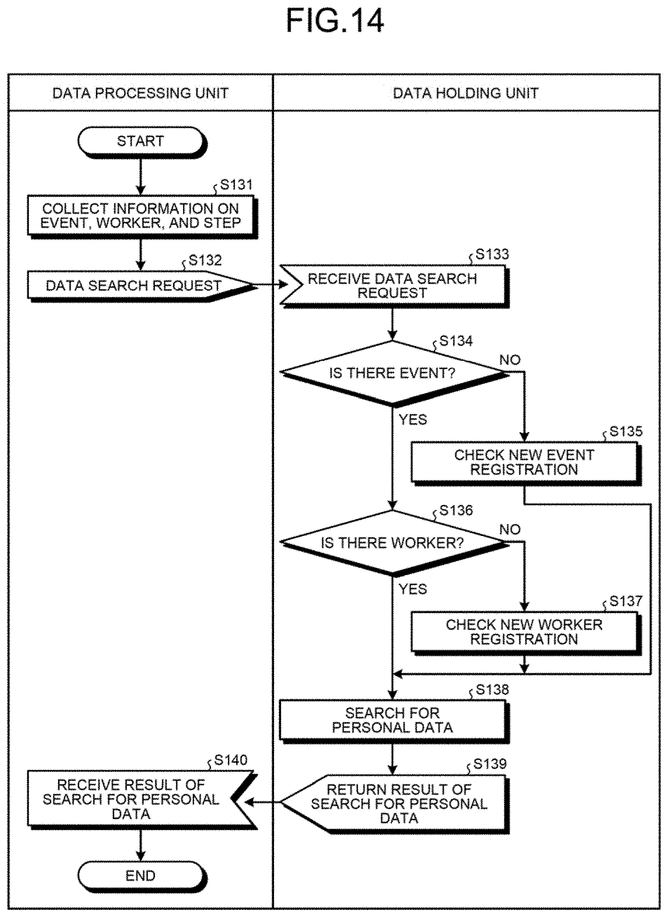

Next, how the process management device 1 searches for personal data for use in adjusting the amount of conveyance of intermediate product will be described with reference to FIGS. 14 to 18.

FIG. 14 is a flowchart illustrating an example of how the process management device 1 searches for personal data according to the first embodiment.

In order for the process management device 1 to search for personal data, as illustrated in FIG. 14, the data processing unit 3 first collects information on an event, a worker, and a step (step S131), and transmits a data search request including the collected information to the data holding unit 4 (step S132). The three pieces of information collected in step S131 are identification information, uniquely indicating an event, a worker, and a step, respectively.

Upon receiving the data search request (step S133), the data holding unit 4 checks whether there is an event corresponding to the event identification information included in the data search request (step S134). When there is an event (step S134: Yes), the data holding unit 4 checks whether there is a worker corresponding to the worker identification information included in the data search request (step S136). When there is a worker (step S136: Yes), the data holding unit 4 searches for personal data corresponding to the event identification information, worker identification information, and step identification information included in the data search request (step S138).

After the search for personal data, the search result is returned to the data processing unit 3 (step S139), and once the data processing unit 3 receives the search result (step S140), the search operation ends.

In addition, when the data held by the data holding unit 4 do not contain data of a corresponding event (step S134: No), the data holding unit 4 checks a new event registration (step S135).

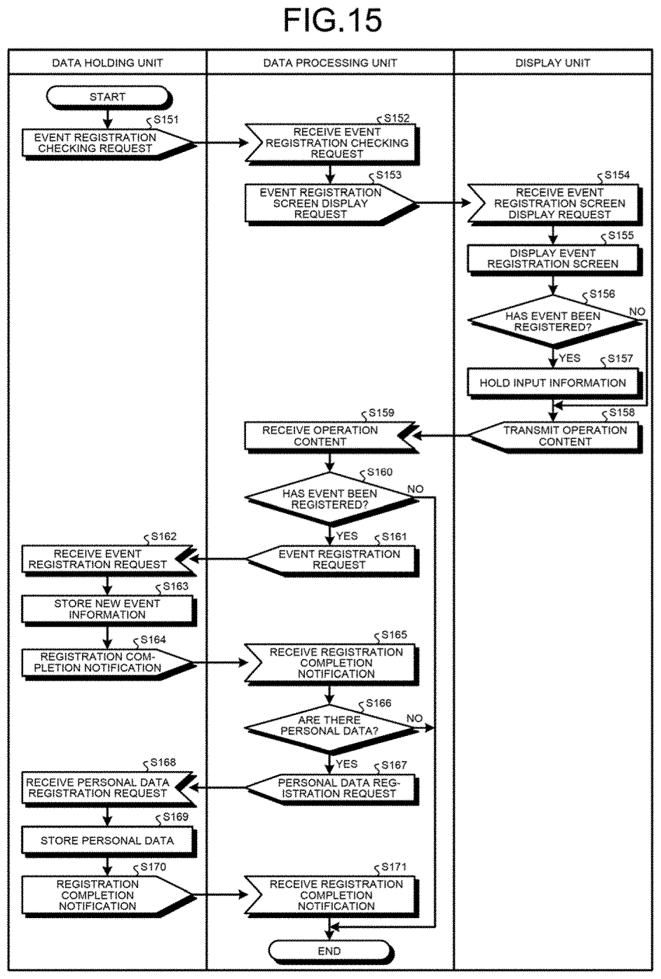

The operation of checking a new event registration in step S135 will be described with reference to FIG. 15. FIG. 15 is a flowchart illustrating an example of how the process management device 1 checks a new event registration according to the first embodiment.

In step S135, which is performed after determining that there is no corresponding event in step S134 of FIG. 14, the data holding unit 4 first transmits an event registration checking request to the data processing unit 3 as illustrated in FIG. 15 (step S151).

Upon receiving the event registration checking request (step S152), the data processing unit 3 transmits an event registration screen display request to the display unit 2 (step S153).

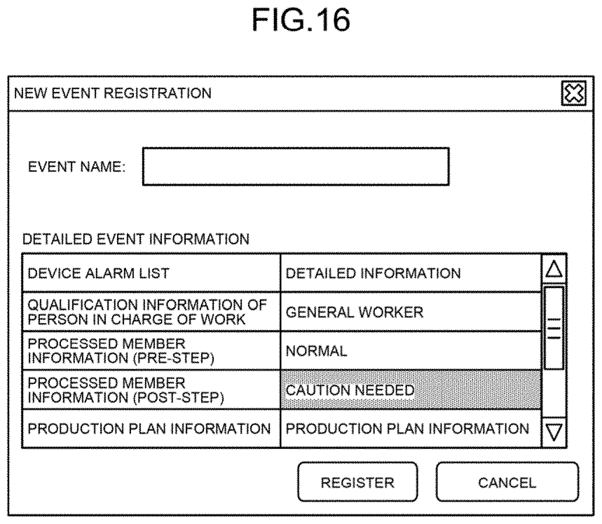

Upon receiving the event registration screen display request (step S154), the display unit 2 displays an event registration screen (step S155). FIG. 16 is a diagram illustrating an exemplary event registration screen that is displayed by the display unit 2 of the process management device 1 according to the first embodiment. The display unit 2 displays in step S155 the event registration screen illustrated in FIG. 16 and waits for an operation by the user, specifically, an operation of inputting an event name or the like. The user of the process management device 1 performs operations such as inputting an event name, checking detailed event information, pressing the “register” button, and pressing the “cancel” button. For newly registering an event, the user presses the “register” button after inputting the event name. On the other hand, when no event is to be registered, the user presses the “cancel” button. The display unit 2 can also receive input of personal data of a worker in step S155.

Returning to FIG. 15, after displaying the event registration screen, the display unit 2 checks whether the operation of registering an event has been performed (step S156). When the operation of registering an event has been performed, that is, the “register” button illustrated in FIG. 16 has been pressed (step S156: Yes), the display unit 2 holds the information input during the display of the event registration screen, for example, the event name (step S157), and transmits information indicating the operation content to the data processing unit 3 (step S158). Here, the information indicating the operation content includes information input while the display unit 2 was displaying the event registration screen illustrated in FIG. 16. In addition, when the operation of registering an event has not been performed, that is, the “cancel” button illustrated in FIG. 16 has been pressed (step S156: No), the process management device 1 transmits information indicating that the operation of canceling the event registration has been performed to the data processing unit 3 (step S158).

Upon receiving the information indicating the operation content (step S159), the data processing unit 3 checks whether the received information indicates that the event registration operation has been performed (step S160), and when the event registration operation has not been performed (step S160: No), the data processing unit 3 ends the operation. On the other hand, when the event registration operation has been performed (step S160: Yes), the data processing unit 3 transmits an event registration request to the data holding unit 4 (step S161). The event registration request includes the information input in step S155 described above.

Upon receiving the event registration request (step S162), the data holding unit 4 stores the information included in the event registration request as new event information (step S163), and transmits a registration completion notification to the data processing unit 3 (step S164).

Upon receiving the registration completion notification on the event (step S165), the data processing unit 3 checks whether there are personal data, that is, whether personal data have been input in step S155 described above (step S166). When there are no personal data (step S166: No), the data processing unit 3 ends the operation. When there are personal data (step S166: Yes), the data processing unit 3 transmits a personal data registration request including the personal data input in step S155 described above to the data holding unit 4 (step S167).

Upon receiving the personal data registration request (step S168), the data holding unit 4 stores the personal data included in the personal data registration request (step S169), and transmits a registration completion notification to the data processing unit 3 (step S170).

Upon receiving the registration completion notification on the personal data (step S171), the data processing unit 3 ends the operation.

Returning to FIG. 14, when the held data do not contain data of a corresponding worker (step S136: No), the data holding unit 4 checks a new worker registration (step S137).

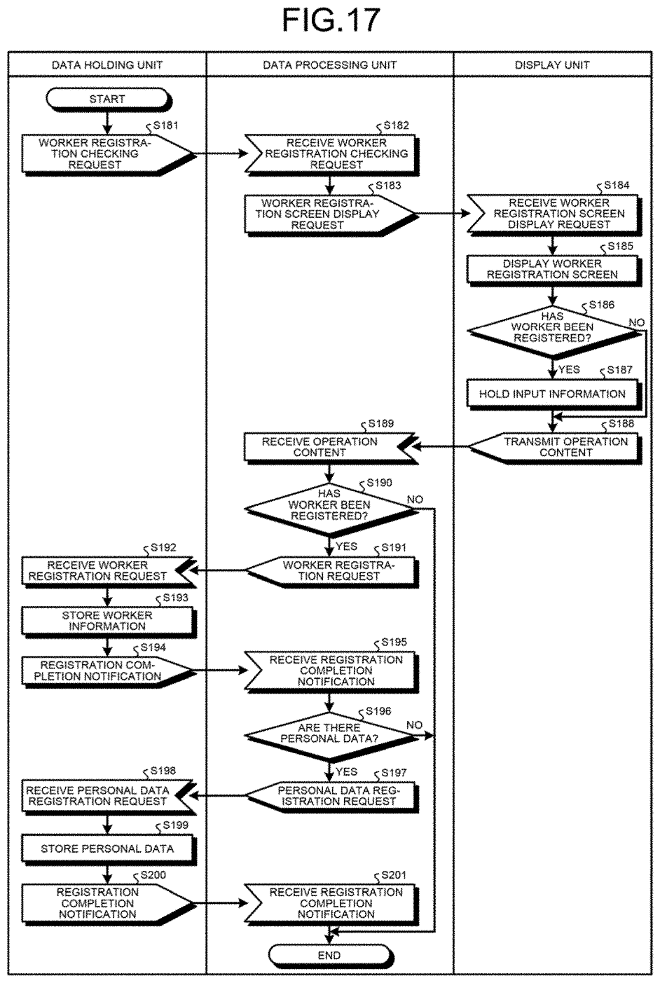

The operation of checking a new worker registration in step S137 will be described with reference to FIG. 17. FIG. 17 is a flowchart illustrating an example of how the process management device 1 checks a new worker registration according to the first embodiment.

In step S137, which is performed after determining that there is no corresponding worker in step S136 of FIG. 14, the data holding unit 4 first transmits a worker registration checking request to the data processing unit 3 as illustrated in FIG. 17 (step S181).

Upon receiving the worker registration checking request (step S182), the data processing unit 3 transmits a worker registration screen display request to the display unit 2 (step S183).

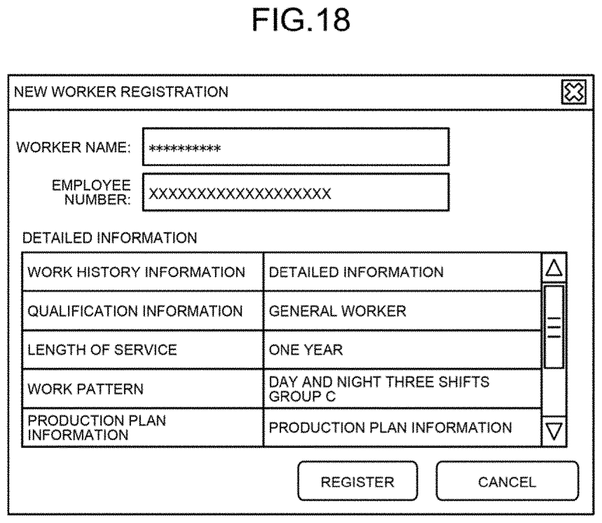

Upon receiving the worker registration screen display request (step S184), the display unit 2 displays a worker registration screen (step S185). FIG. 18 is a diagram illustrating an exemplary worker registration screen that is displayed by the display unit 2 of the process management device 1 according to the first embodiment. The display unit 2 displays in step S185 the worker registration screen illustrated in FIG. 18 and waits for an operation by the user, specifically, an operation of inputting a worker name, an employee number, or the like. The user of the process management device 1 performs operations such as inputting a worker name, inputting an employee number, checking detailed worker information, pressing the “register” button, and pressing the “cancel” button. For newly registering a worker, the user presses the “register” button after inputting the worker name, employee number, or the like. On the other hand, when no worker is to be registered, the user presses the “cancel” button.

Returning to FIG. 17, after displaying the worker registration screen, the display unit 2 checks whether the operation of registering a worker has been performed (step S186). When the operation of registering a worker has been performed, that is, the “register” button illustrated in FIG. 18 has been pressed (step S186: Yes), the display unit 2 holds the information input during the display of the worker registration screen, for example, the worker name and employee number (step S187), and transmits information indicating the operation content to the data processing unit 3 (step S188). Here, the information indicating the operation content includes information input while the display unit 2 was displaying the worker registration screen illustrated in FIG. 18. In addition, when the operation of registering a worker has not been performed, that is, the “cancel” button illustrated in FIG. 18 has been pressed (step S186: No), the process management device 1 transmits information indicating that the operation of canceling the worker registration has been performed to the data processing unit 3 (step S188).

Upon receiving the information indicating the operation content (step S189), the data processing unit 3 checks whether the received information indicates that the worker registration operation has been performed (step S190), and when the worker registration operation has not been performed (step S190: No), the data processing unit 3 ends the operation. On the other hand, when the worker registration operation has been performed (step S190: Yes), the data processing unit 3 transmits a worker registration request to the data holding unit 4 (step S191). The worker registration request includes the information input in step S185 described above.

Upon receiving the worker registration request (step S192), the data holding unit 4 stores the new worker information included in the worker registration request (step S193), and transmits a registration completion notification to the data processing unit 3 (step S194).

Upon receiving the registration completion notification on the worker information (step S195), the data processing unit 3 checks whether there are personal data, that is, whether personal data have been input in step S185 described above (step S196). When there are no personal data (step S196: No), the data processing unit 3 ends the operation. When there are personal data (step S196: Yes), the data processing unit 3 transmits a personal data registration request including the personal data input in step S185 described above to the data holding unit 4 (step S197).

Upon receiving the personal data registration request (step S198), the data holding unit 4 stores the personal data included in the personal data registration request (step S199), and transmits a registration completion notification to the data processing unit 3 (step S200).

Upon receiving the registration completion notification on the personal data (step S201), the data processing unit 3 ends the operation.

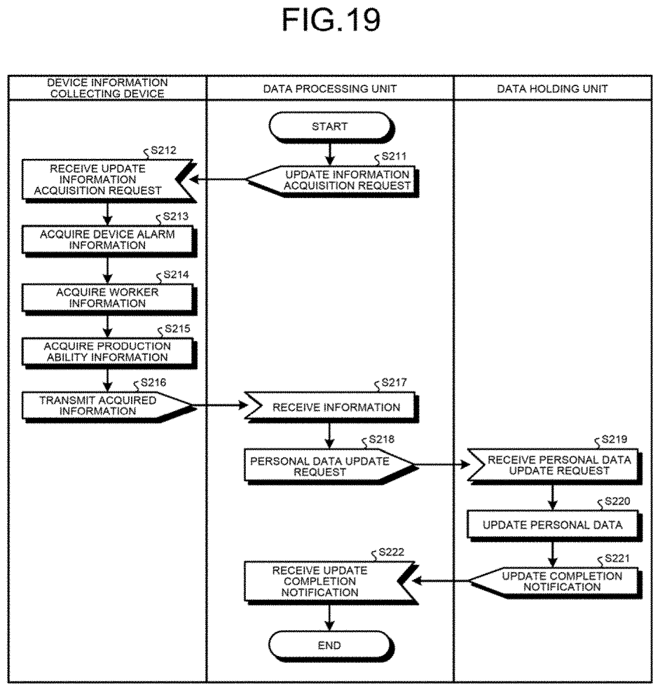

Next, how the process management device 1 updates personal data for use in adjusting the amount of conveyance of intermediate product will be described with reference to FIG. 19.

FIG. 19 is a flowchart illustrating an example of how the process management device 1 updates personal data according to the first embodiment. The process management device 1 executes the operation of updating personal data illustrated in FIG. 19 at a predetermined timing. For example, the process management device 1 repeatedly performs the operation of updating personal data at regular intervals during the manufacture of products in the production process 6.

In order for the process management device 1 to update personal data, as illustrated in FIG. 19, the data processing unit 3 first transmits an update information acquisition request to the device information collecting device 61 (step S211). At this time, the data processing unit 3 transmits an update information acquisition request including information specifying one production device.

Upon receiving the update information acquisition request (step S212), the device information collecting device 61 acquires device alarm information, worker information, and production ability information from the specified production device (steps S213, S214, and S215).

After executing steps S212 to S215, the device information collecting device 61 transmits the information acquired in each of these steps to the data processing unit 3 (step S216).

Upon receiving the information from the device information collecting device 61 (step S217), the data processing unit 3 transmits a personal data update request to the data holding unit 4 (step S218). The personal data update request includes the information received in step S217.

Upon receiving the personal data update request (step S219), the data holding unit 4 updates personal data by registering the information included in the personal data update request with personal data (step S220).

Once the update of personal data is completed, the data holding unit 4 transmits a completion notification to the data processing unit 3 (step S221).

Upon receiving the update completion notification (step S222), the data processing unit 3 ends the operation.

The process management device 1 periodically performs the operation illustrated in FIG. 19 for all the production devices to update the personal data of each worker.

The update of personal data may be performed by the conveyance amount adjustment unit 32 or the event information management unit 33 of the data processing unit 3. A data processing unit for updating personal data may be separately provided in the data processing unit 3.

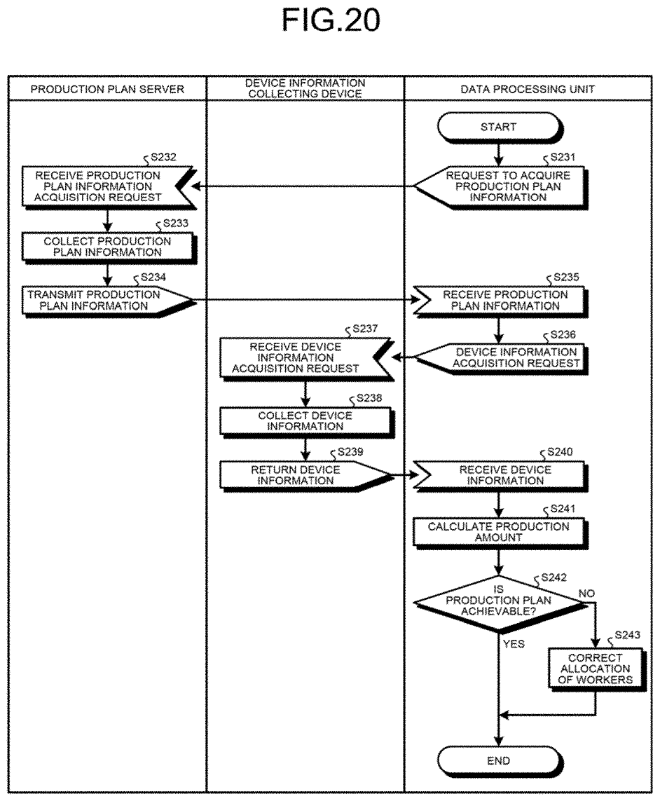

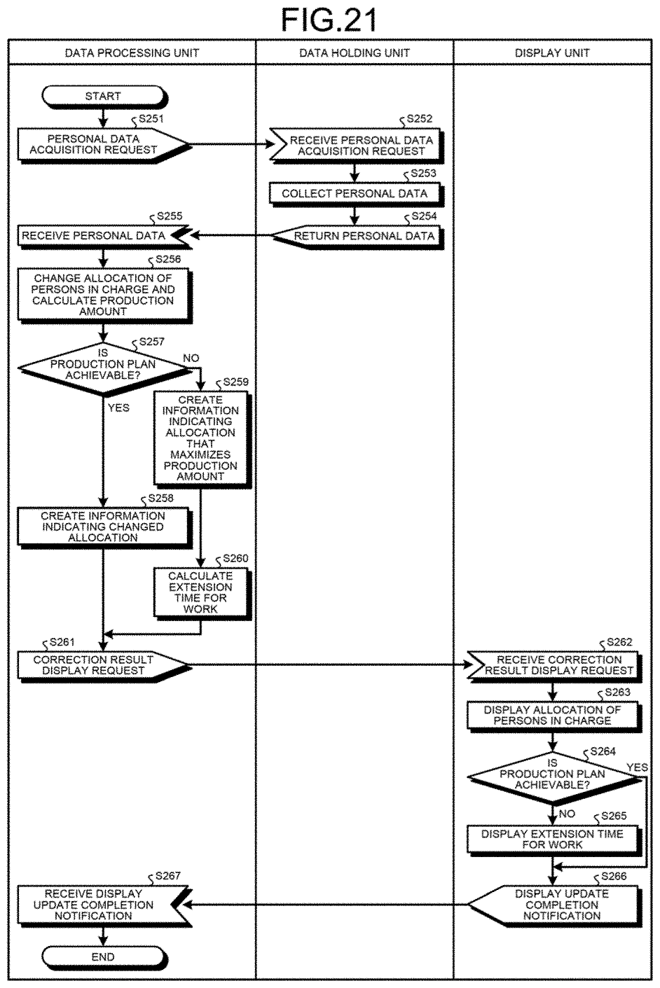

Next, how the process management device 1 changes the allocation of workers in charge of the production process 6 will be described with reference to FIGS. 20 and 21.

FIG. 20 is a flowchart illustrating an example of how the process management device 1 checks whether it is necessary to change the allocation of workers in charge of the production process 6 according to the first embodiment.

In order for the process management device 1 to check whether it is necessary to change the allocation of workers in charge of the production process 6, as illustrated in FIG. 20, the data processing unit 3 first transmits a production plan information acquisition request to the production plan server 5 (step S231). Note that the processing of the data processing unit 3 illustrated in FIG. 20 is performed by the work assignment changing unit 35 of the data processing unit 3. Upon receiving the production plan information acquisition request (step S232), the production plan server 5 collects production plan information corresponding to the production plan information acquisition request, and transmits the production plan information to the data processing unit 3 (steps S233 and S234).

Upon receiving the production plan information from the production plan server 5 (step S235), the data processing unit 3 next transmits a device information acquisition request to the device information collecting device 61 (step S236). Note that in step S236, the data processing unit 3 transmits a device information acquisition request to the device information collecting devices 61 in all the steps of the production process 6 to request information on all the production devices in the process.

Upon receiving the device information acquisition request (step S237), the device information collecting device 61 collects device information on each production device in the step (step S238). Device information that is collected by the device information collecting device 61 includes event determination information including device alarm information and the like, worker information, pre-step capacity (capacity of pre-step processed member yards), and post-step capacity (capacity of post-step processed member yards). The device information collecting device 61 returns the collected device information to the data processing unit 3 (step S239).

Upon receiving the device information (step S240), the data processing unit 3 calculates the production amount in the entire production process 6 based on the device information acquired from all the production devices in all the steps of the production process 6 (step S241). The data processing unit 3 calculates the production ability of each production device from the device information, and further calculates the production amount in the entire production process 6.

Next, the data processing unit 3 compares the production amount calculated in step S241 with the production plan information received in step S235 to check whether the production plan is achievable (step S242), and when the production plan is achievable (step S242: Yes), the data processing unit 3 ends the operation.

When the production plan is not achievable (step S242: No), the data processing unit 3 corrects the allocation of workers using the method illustrated in FIG. 21 (step S243), and ends the operation. The correction of the allocation of workers is a change of the allocation of persons in charge of work to each step of the production process 6.

FIG. 21 is a flowchart illustrating an example of how the process management device 1 corrects the allocation of workers in charge of the production process 6 according to the first embodiment.

In response to determining in step S242 of FIG. 20 that the production plan is not achievable, the data processing unit 3 of the process management device 1 transmits a personal data acquisition request to the data holding unit 4 as illustrated in FIG. 21 (step S251). At this time, the data processing unit 3 requests the acquisition of personal data of workers for all the production devices in all the steps of the production process 6.

Upon receiving the personal data acquisition request (step S252), the data holding unit 4 collects the personal data of all the workers who use the production devices in each step of the production process 6 (step S253), and returns the collected personal data (step S254).

Upon receiving the personal data (step S255), the data processing unit 3 changes the allocation of persons in charge of the work of each step and calculates the production amount with the changed allocation, based on the received personal data and the device information received in step S240 of FIG. 20 (step S256). Then, the data processing unit 3 checks whether the production plan can be achieved by changing the allocation of persons in charge (step S257). When the production plan is achievable (step S257: Yes), the data processing unit 3 creates information indicating the changed allocation of persons in charge (step S258), and transmits a correction result display request to the display unit 2 together with the created information (step S261). In addition, when the production plan is not achievable (step S257: No), the data processing unit 3 creates information indicating an allocation of persons in charge that maximizes the production amount (step S259). Next, the data processing unit 3 obtains the difference between the maximum production amount and the production plan, and calculates an extension time for work based on the obtained difference (step S260). Next, the data processing unit 3 transmits a correction result display request to the display unit 2 together with the information created in step S259 and information indicating the extension time calculated in step S260 (step S261).

Upon receiving the correction result display request (step S262), the display unit 2 displays the corrected allocation of persons in charge (step S263). In addition, the display unit 2 checks whether the production plan is achievable, that is, whether the information received in step S262 includes information indicating the extension time for work (step S264), and when the production plan is achievable (step S264: Yes), the display unit 2 notifies the data processing unit 3 of the display update completion (step S266). When the production plan is not achievable (step S264: No), the display unit 2 displays the extension time for work (step S265), and notifies the data processing unit 3 of the display update completion (step S266).

Upon receiving the display update completion notification (step S267), the data processing unit 3 ends the operation.

The process management device 1 regularly executes the operation represented by the flowcharts illustrated in FIGS. 20 and 21 to appropriately correct the production plan according to the situation of the production site. The process management device 1 may correct the production plan in response to receiving an operation from the user.

As described above, the process management device 1 according to the present embodiment creates and holds personal data indicating the production ability of each worker for each step that the worker is in charge of and for each event that occurs, and adjusts the path and amount of conveyance of intermediate product between adjacent steps based on the personal data and the status of event occurrence. In addition, the process management device 1 determines whether it is necessary to change the allocation of persons in charge of work based on the personal data, the status of event occurrence, and the production plan, and in response to determining that it is necessary to change the allocation, changes the allocation to an allocation that makes the production plan achievable or an allocation that maximizes the production ability. The process management device 1 according to the present embodiment makes it possible to prevent the occurrence of excess or deficiency of intermediate products conveyed between two adjacent steps, and to increase the production efficiency of the entire production process by setting a work allocation that increases the production ability of persons in charge. Therefore, the production efficiency can be improved.

Note that the present embodiment has assumed for convenience of explanation that workers in each step use production devices to perform various types of work for manufacturing products. However, the process management device is also applicable to a production process in which in part or the whole of each step, workers manually manufacture intermediate products without using a production device. In this case, an information collecting device corresponding to the above-described device information collecting device is provided in each step, and the information collecting device collects the above-described pre-step capacity and post-step capacity, worker identification information, and information that may affect the production ability of workers (for example, work environment information such as temperature and humidity, elapsed time from the start of work, worker body temperature, and the like). The process management device adjusts the path and amount of conveyance of intermediate product based on the information collected by each information collecting device.

### Second Embodiment

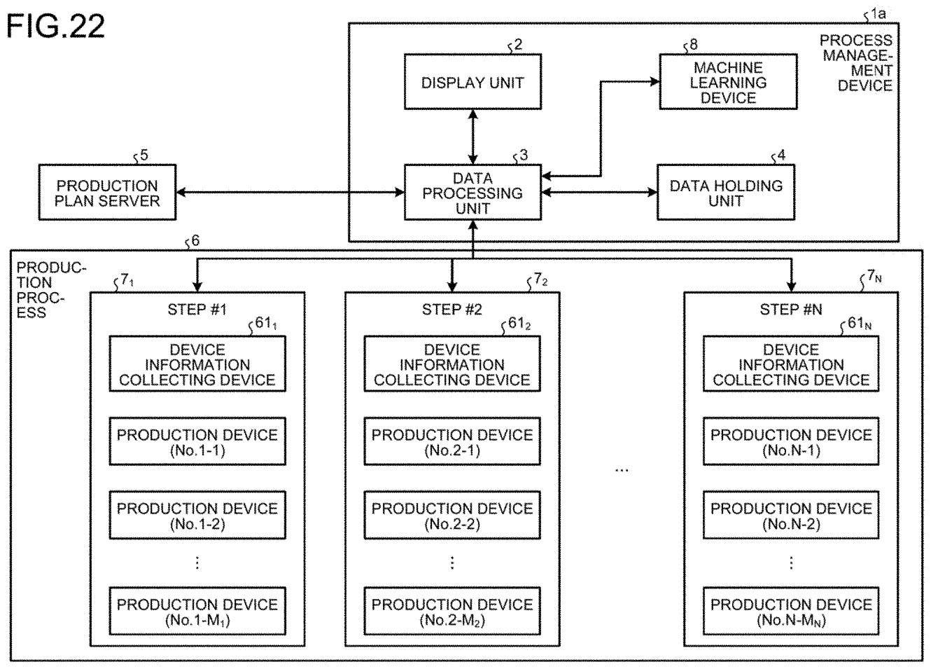

FIG. 22 is a diagram illustrating an exemplary configuration of a production system including a process management device according to a second embodiment of the present invention. The production system illustrated in FIG. 22 is configured by replacing the process management device 1 of the production system in FIG. 1 described in the first embodiment with a process management device 1a. Because the components other than the process management device 1a are the same as those of the production system illustrated in FIG. 1, the description thereof will be omitted.

The process management device 1a according to the second embodiment includes a machine learning device 8 in addition to the components of the process management device 1 according to the first embodiment. In the present embodiment, differences from the process management device 1 according to the first embodiment will be described, and the description of similarities to the process management device 1 will be omitted.

When the data processing unit 3 of the process management device 1a optimizes each step by adjusting the amount of conveyance to each worker for conveying intermediate products manufactured in each step of the production process 6 to the next step in a similar manner to that in the first embodiment, the machine learning device 8 performs learning processing using learning data generated based on the information used for optimizing each step and the result of optimization of each step. Specifically, the machine learning device 8 learns how to optimize each step of the production process 6 using learning data. How to optimize the learning target is in particular how the data processing unit 3 optimizes each step of the production process 6 such that the difference between the total amount of final product to be produced by the designated time and the production plan approaches zero. As described in the first embodiment, the optimization of each step of the production process 6 is performed by adjusting the amount of conveyance to each worker for conveying intermediate products manufactured in each step to the next step, that is, by adjusting the distribution. A learned model that is the result of learning by the machine learning device 8 is used for processing in which the data processing unit 3 optimizes each step of the production process 6. That is, in the process management device 1a, the data processing unit 3 optimizes each step of the production process 6 in the same manner as described in the first embodiment until the learning by the machine learning device 8 sufficiently proceeds. In addition, after the learning by the machine learning device 8 is sufficiently performed, the data processing unit 3 optimizes each step of the production process 6 using the result of learning by the machine learning device 8.

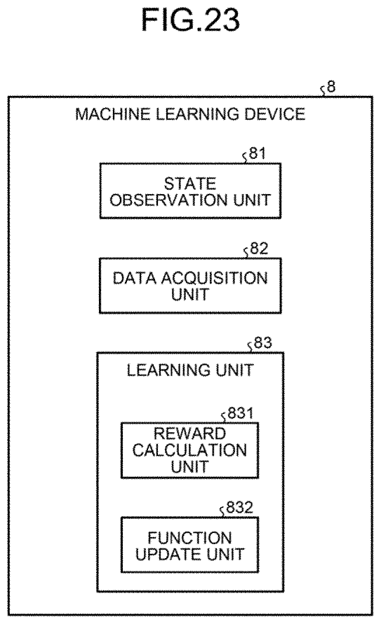

FIG. 23 is a diagram illustrating an exemplary configuration of the machine learning device 8. The machine learning device 8 includes a state observation unit 81, a data acquisition unit 82, and a learning unit 83. The learning unit 83 includes a reward calculation unit 831 and a function update unit 832.

The state observation unit 81 observes, as state variables, the status of event occurrence in each step of the production process 6, capacity information indicating the state of the processed member yards (pre-step processed member yards and post-step processed member yards) provided before and after each step of the production process 6, personal data of each person in charge of each step of the production process 6, the amount of final product produced by the current time, and the result of distribution adjustment.

The data acquisition unit 82 acquires production plan information in the production process 6.

The learning unit 83 learns how to optimize each step of the production process 6 such that the difference between the total amount of final product to be produced by the designated time and the production plan associated with the designated time approaches zero according to the data set created based on the state variables observed by the state observation unit 81 and the production plan information acquired by the data acquisition unit 82.

The learning unit 83 may use any learning algorithm. As an example, a case where reinforcement learning is applied will be described. In reinforcement learning, an agent (subject of an action) in an environment observes the current state and determines the action to take. The agent gains a reward from the environment by selecting an action, and learns how to maximize the reward through a series of actions. Q-learning and TD-learning are known as representative methods of reinforcement learning. For example, in the case of Q-learning, an action value table that is a general update expression for the action value function Q (s, a) is expressed by Formula (1) below.

$$\begin{matrix}[ Formula 1 ] & \\ Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) & ( 1 )\end{matrix}$$

In Formula (1), sₜ represents the environment at time t, and aₜ represents the action at time t. The action aₜ changes the environment to sₜ₊₁. In addition, rₜ₊₁ represents the reward that can be gained due to the change of the environment, γ represents a discount rate, and α represents a learning coefficient. Note that γ is in the range of 0<γ≤1, and α is in the range of 0<α≤1. In the case that Q-learning is applied, the action aₜ is to optimize each step of the production process 6 such that the difference between the total amount of final product to be produced by the designated time and the production plan associated with the designated time approaches zero.

The update expression represented by Formula (1) increases the action value Q when the action value Q of the best action a at time t+1 is greater than the action value Q of the action a executed at time t, and otherwise reduces the action value Q. In other words, the action value function Q (s, a) is updated such that the action value Q of the action a at time t is brought closer to the best action value at time t+1. As a result, the best action value in a certain environment sequentially propagates to the action values in the previous environments.

The reward calculation unit 831 calculates a reward based on state variables. The reward calculation unit 831 calculates the reward r based on the difference between the total amount of final product to be produced by the designated time and the production plan associated with the designated time. For example, in a case where the difference is less than or equal to a threshold, the reward r is increased (for example, a reward of “1” is given). On the other hand, in a case where the difference is greater than the threshold, the reward r is reduced (for example, a reward of “−1” is given).

The total amount of final product to be produced by the designated time is calculated based on information output from the device information collecting device 61 installed in each step of the production process 6. For example, the production ability of the production process 6 at the current point of time is calculated, and the total amount of final product to be produced in the period from the current point of time to the designated time on the assumption that there is no change in the calculated production ability is added to the amount of final product produced by the current time, whereby the total amount of final product to be produced by the designated time is obtained. The above-described threshold that the reward calculation unit 831 uses to calculate the reward may simply be the number of final products or may be a ratio value. Alternatively, the threshold may be calculated or determined through learning using external information such as the status of order reception for the final product and the capacity of a warehouse where the final product is stored before shipment.

The function update unit 832 updates, according to the reward calculated by the reward calculation unit 831, a function for optimizing each step of the production process 6 such that the difference between the total amount of final product to be produced by the designated time and the production plan associated with the designated time approaches zero. For example, in the case of Q-learning, the action value function Q (sₜ, aₜ) represented by Formula (1) is used as a function for optimizing each step of the production process 6 such that the difference between the total amount of final product to be produced by the designated time and the production plan associated with the designated time approaches zero.

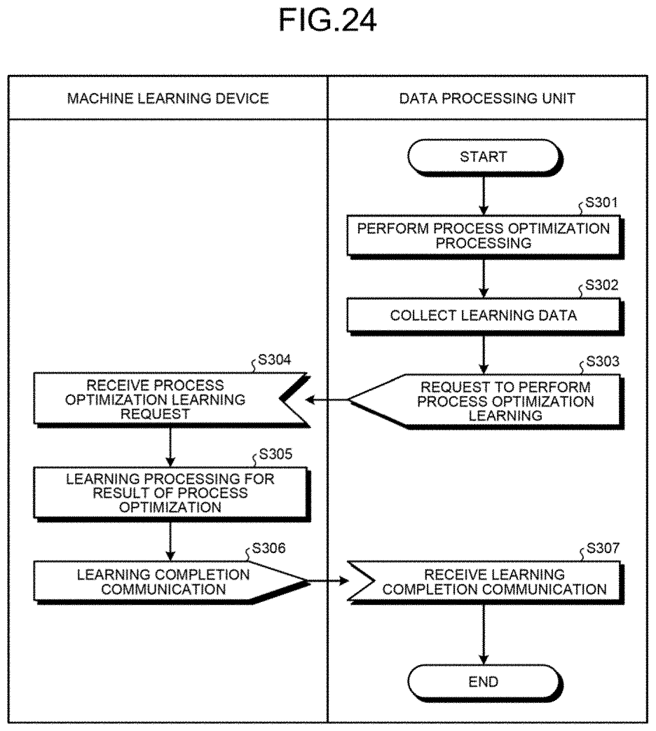

Next, the operation of the process management device 1a according to the second embodiment will be described in detail. FIG. 24 is a flowchart illustrating an example of the operation of the process management device 1a according to the second embodiment. The flowchart of FIG. 24 illustrates the operation of the machine learning device 8 and the data processing unit 3 of the process management device 1a in the case that the machine learning device 8 learns how to optimize each step of the production process 6.

In order for the machine learning device 8 to learn how to optimize each step of the production process 6, the data processing unit 3 first performs process optimization processing (step S301). That is, the data processing unit 3 optimizes each step of the production process 6 in a similar procedure to that described in the first embodiment.

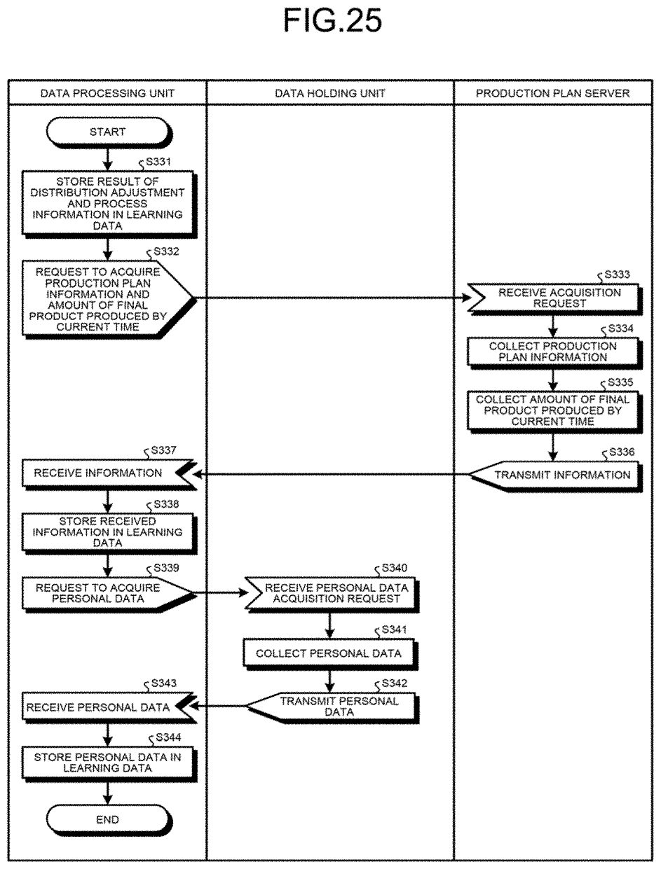

Next, the data processing unit 3 collects learning data for use in learning processing by the machine learning device 8 (step S302). Details of this step S302 are illustrated in FIG. 25. FIG. 25 is a flowchart illustrating how the data processing unit 3 collects learning data according to the second embodiment.

First, the data processing unit 3 stores the result of distribution adjustment and process information in learning data (step S331). The result of distribution adjustment is the result of optimization of each step of the production process 6. The process information as used herein includes information indicating the status of event occurrence in each step of the production process 6, information on the capacity of the processed member yards (pre-step processed member yards and post-step processed member yards) before and after each step, and information on the persons in charge of each step.

Next, the data processing unit 3 requests the production plan server 5 to acquire production plan information and the amount of final product produced by the current time (steps S332 and S333).

The production plan server 5 that has received the request in step S333 collects production plan information (step S334), further collects the amount of final product produced by the current time (step S335), and transmits the collected information to the data processing unit 3 (step S336).

Upon receiving the information (production plan information and amount of final product produced by the current time) transmitted from the production plan server 5 (step S337), the data processing unit 3 stores the received information in learning data (step S338).

Next, the data processing unit 3 requests the data holding unit 4 to acquire personal data (steps S339 and S340).

The data holding unit 4 that has received the request in step S340 collects personal data (step S341), and transmits the collected personal data to the data processing unit 3 (step S342).

Upon receiving the personal data transmitted from the data holding unit 4 (step S343), the data processing unit 3 stores the personal data in learning data (step S344).

Returning to FIG. 24, after the collection of learning data, the data processing unit 3 requests the machine learning device 8 to perform process optimization learning (step S303). At this time, the data processing unit 3 transmits the collected learning data to the machine learning device 8.

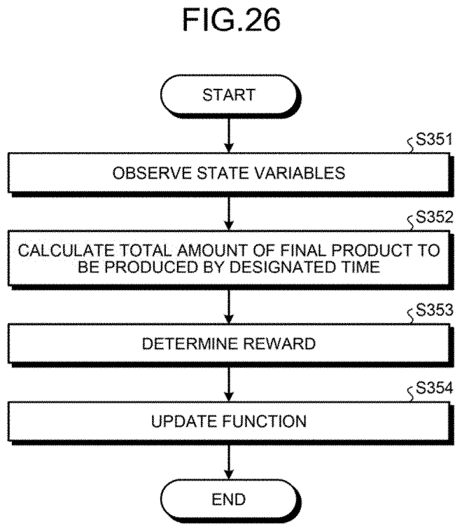

Upon receiving the process optimization learning request (step S304), the machine learning device 8 performs learning processing for the result of process optimization (step S305). Learning processing by the machine learning device 8 is illustrated in FIG. 26.

FIG. 26 is a flowchart illustrating an example of learning processing by the machine learning device 8. The machine learning device 8 first observes state variables (step S351). Specifically, the state observation unit 81 of the machine learning device 8 observes, as state variables, information on the status of event occurrence in each step of the production process 6, information on the persons in charge of each step, and personal data among the information stored in the learning data received from the data processing unit 3.

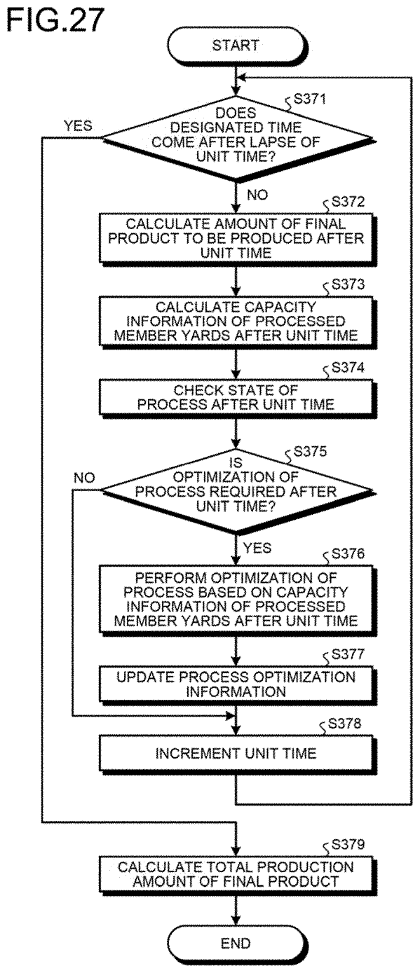

Next, the machine learning device 8 calculates the total amount of final product to be produced by the designated time (step S352). In this step S352, the machine learning device 8 virtually performs the checking of the state of each step and the optimization of each step according to the flowchart illustrated in FIG. 27 to calculate the total production amount of final product. FIG. 27 is a flowchart illustrating an example of how the machine learning device 8 calculates the total production amount of final product. The designated time is, for example, the finish time of the production process. Alternatively, the designated time may be the time at which a designated period of time has elapsed from the current point of time. Note that the present embodiment is based on the premise that the data acquisition unit 82 operates as a calculation unit that calculates the total production amount of final product, but the reward calculation unit 831 may calculate the total production amount of final product. Alternatively, the data processing unit 3 may be configured to calculate the total production amount of final product, and pass information on the calculated total production amount to the machine learning device 8.

The data acquisition unit 82 first checks whether the designated time comes after a lapse of a unit time (step S371). The unit time is a preset length of time such as five minutes or ten minutes.

When the designated time does not come after a lapse of the unit time (step S371: No), the data acquisition unit 82 calculates the amount of final product that will have been produced after the unit time (step S372). Specifically, the data acquisition unit 82 calculates the amount of final product that will have been produced after the unit time based on the amount of final product produced by the current point of time and information on the status of event occurrence in each step of the production process 6, information on the persons in charge of each step, and personal data stored in the learning data received from the data processing unit 3. More specifically, the data acquisition unit 82 obtains the current production ability based on information on the status of event occurrence in each step of the production process 6, information on the persons in charge of each step, and personal data, further calculates the production amount of final product per unit time based on the current production ability, and adds this to the amount of final product produced by the current point of time, thereby obtaining the amount of final product that will have been produced after the unit time.

Next, the data acquisition unit 82 calculates capacity information of the processed member yards after the unit time (step S373). That is, the data acquisition unit 82 calculates capacity information of each of the pre-step processed member yards and the post-step processed member yards in each step of the production process 6 after the unit time. The calculation of capacity information of the processed member yards after the unit time is performed based on the current production ability of each step of the production process 6 and the capacity information of each of the processed member yards (pre-step processed member yards and post-step processed member yards) at the current point of time.

Next, the data acquisition unit 82 checks the state of the process after the unit time (step S374). Specifically, the data acquisition unit 82 checks the state of the processed member yards in each step of the production process 6 after the unit time.

Next, the data acquisition unit 82 checks whether the optimization of the process is required after the unit time (step S375). The data acquisition unit 82 checks the capacity information of the processed member yards in each step of the production process 6 after the unit time, and determines that the optimization of the process is required when one or more processed member yards in which the capacity has reached the upper limit or lower limit. For example, the data acquisition unit 82 determines that a processed member yard having a use rate of 90% or more has reached the upper limit of capacity, and determines that a processed member yard having a use rate of 10% or less has reached the lower limit of capacity.

When the optimization of the process is required after the unit time (step S375: Yes), the data acquisition unit 82 performs the optimization of each step of the production process 6 based on the capacity information of the processed member yards after the unit time (step S376). The optimization of each step of the production process 6 is performed in a similar manner to the case when the data processing unit 3 optimizes each step of the production process 6.

Next, the data acquisition unit 82 updates process optimization information (step S377). The process optimization information is information indicating the amount of conveyance for each route of conveyance of intermediate product manufactured in each step of the production process 6 to the next step.

Next, the data acquisition unit 82 increments the unit time (step S378), and returns to step S371. On the other hand, when the optimization of the process is not required after the unit time (step S375: No), the data acquisition unit 82 increments the unit time (step S378), and returns to step S371. After returning to step S371, the data acquisition unit 82 continues the operation assuming that the current time has advanced by the unit time.

In addition, when the designated time comes after a lapse of the unit time (step S371: Yes), the data acquisition unit 82 calculates the total production amount of final product (step S379). The data acquisition unit 82 calculates the total production amount of final product in a similar manner to the case of calculating in step S372 the amount of final product that will have been produced after the unit time. That is, the data acquisition unit 82 executes a similar processing to that in step S372 to calculate the amount of final product that will have been produced after the unit time, and sets this as the total production amount of final product, that is, the total amount of final product to be produced by the designated time.

Returning to FIG. 26, the machine learning device 8 executes step S352 to calculate the total amount of final product to be produced by the designated time, and then determines the reward (step S353). Specifically, the reward calculation unit 831 of the learning unit 83 obtains the difference between the total amount of final product to be produced by the designated time and the production plan associated with the designated time, compares the obtained difference with the threshold, and determines the reward. Note that the production plan associated with the designated time is calculated based on the production plan information extracted from the learning data by the data acquisition unit 82.

Next, the machine learning device 8 updates, according to the reward determined in step S353, the function for optimizing each step of the production process 6 such that the difference between the total amount of final product to be produced by the designated time and the production plan associated with the designated time approaches zero (step S354).

Returning to FIG. 24, after the learning processing in step S305, the machine learning device 8 transmits a learning completion communication to the data processing unit 3 (step S306). Once the data processing unit 3 receives the learning completion communication transmitted by the machine learning device 8 in step S306 (step S307), the learning operation ends.

The learning operation illustrated in FIG. 24 is executed every time the data processing unit 3 optimizes each step of the production process 6 until how to optimize each step of the production process 6 such that the difference between the total amount of final product to be produced by the designated time and the production plan associated with the designated time approaches zero is sufficiently learned.

Once the machine learning device 8 finishes learning how to optimize each step of the production process 6 such that the difference between the total amount of final product to be produced by the designated time and the production plan associated with the designated time approaches zero, the machine learning device 8 may execute step S306 described above to transmit a learning completion communication.

Note that although the present embodiment has described the case where reinforcement learning is applied to the learning algorithm used by the learning unit 83, the present invention is not limited thereto. As the learning algorithm, supervised learning, unsupervised learning, semi-supervised learning, or the like can be applied instead of reinforcement learning.

The above-described learning algorithm can also be deep learning, which learns feature extraction directly. Alternatively, other known methods such as neural networks, genetic programming, functional logic programming, and support vector machines can be used to execute machine learning.

Note that the machine learning device 8 may be a device separate from the process management device 1a and connected to the process management device 1a via a network, for example. Alternatively, as illustrated in FIG. 22, the machine learning device 8 may be incorporated in the process management device 1a. Still alternatively, the machine learning device 8 may exist on a cloud server.

In addition, the machine learning device 8 may learn how to perform optimization to bring the difference between the total amount of final product to be produced by the designated time and the production plan closer to zero according to data sets created for a plurality of process management devices 1a. Note that the machine learning device 8 may acquire data sets from a plurality of process management devices 1a used in the same site, or may use data sets collected by a plurality of process management devices 1a independently used in different sites so as to learn how to perform optimization to bring the difference between the total amount of final product to be produced by the designated time and the production plan closer to zero. Further, in the middle of learning, it is possible to start collecting data sets from a new process management device 1a, or conversely, stop collecting data sets from some process management device 1a. Further, a machine learning device that has learned for a certain process management device 1a how to perform optimization to bring the difference between the total amount of final product to be produced by the designated time and the production plan closer to zero may be attached to a process management device 1a different from this process management device 1a, and how to perform optimization to bring the difference between the total amount of final product to be produced by a different designated time and the production plan closer to zero may be relearned for update.

After the learning by the machine learning device 8 is completed, the data processing unit 3 uses the result of learning by the machine learning device 8 when optimizing each step of the production process 6. In a case where the machine learning device 8 performs the reinforcement learning described above, the data processing unit 3 optimizes each step of the production process 6 using the above-described action value function Q (s, a) updated by the machine learning device 8.

As described above, the process management device 1a according to the present embodiment includes the machine learning device 8 that observes, as state variables, the status of event occurrence in each step of the production process 6, capacity information of the processed member yards before and after each step, personal data of each person in charge of each step, the result of optimization of each step of the production process 6, and the amount of final product produced by the current time, and learns how to perform optimization to bring the difference between the total amount of final product to be produced by the designated time and the production plan closer to zero based on the state variables and the production plan. After the learning by the machine learning device 8 is finished, the data processing unit 3 of the process management device 1a optimizes each step of the production process 6 using the result of learning. As a result, after the learning by the machine learning device 8 is finished, the data processing unit 3 can optimize each step of the production process 6 without executing complicated processing, and the time required for optimization processing can be shortened.

The configurations described in the above-mentioned embodiments indicate examples of the contents of the present invention. The configurations can be combined with another well-known technique, and some of the configurations can be omitted or changed in a range not departing from the gist of the present invention.

### REFERENCE SIGNS LIST

1, 1a process management device; 2 display unit; 3 data processing unit; 4 data holding unit; 5 production plan server; 6 production process; 7₁, 7₂, 7_{N} step; 8 machine learning device; 31 production amount calculation unit; 32 conveyance amount adjustment unit; 33 event information management unit; 34 display control unit; 35 work assignment changing unit; 41 data search unit; 42 personal data storage area; 61₁, 61₂, 61_{N} device information collecting device; 81 state observation unit; data acquisition unit; 83 learning unit; 611 information collecting unit; 612 pre-step capacity measurement unit; 613 post-step capacity measurement unit; 614 event determination information generation unit; 831 reward calculation unit; 832 function update unit.

1. A process management device comprising:
status checking circuitry to check a status of event occurrence in a subsequent step, the status of event occurrence being related to an event that affects a production ability of the subsequent step, the subsequent step being a later one of adjacent two steps;
distribution adjustment circuitry to adjust, based on personal data and a result of checking by the status checking circuitry, distribution of intermediate products manufactured in a preceding step to workers who perform work of the subsequent step, the personal data indicating a production ability of each of the workers according to the status of event occurrence, the preceding step being an earlier one of the two adjacent steps; and
data update circuitry to update the personal data by collecting information on an operating state of each production device installed in the subsequent step, environment information of a place where each production device is installed, identification information of a worker who uses each production device, and information on a current production ability of each worker in the subsequent step, wherein
the distribution adjustment circuitry repeatedly executes the process of adjusting the distribution, observes, as state variables, the status of event occurrence and the personal data when executing the process of adjusting the distribution, then learns the distribution according to a training data set created based on the state variables and a use rate of each pre-step processed member yard in which intermediate products are placed before being subjected to work, the pre-step processed member yard being provided in a preceding stage of a production device installed in each step, and determines the distribution based on a result of learning obtained so far in the process of adjusting the distribution.

2. The process management device according to claim 1, wherein
the personal data includes information indicating a production ability for each of a plurality of events that affect the production ability of the subsequent step and for each of a plurality of workers.

3. The process management device according to claim 1, wherein
in a case where one production process includes multiple sets of two adjacent steps, the distribution adjustment circuitry performs a process of adjusting the distribution sequentially for all the sets of two adjacent steps.

4. The process management device according to claim 1, wherein
in a case where the production ability of the subsequent step is lower than or equal to a production ability of the preceding step, the distribution adjustment circuitry adjusts the distribution of intermediate products manufactured in the preceding step to the workers.

5. The process management device according to claim 1, wherein
a pre-step processed member yard in which intermediate products are placed before being subjected to work is individually provided in a preceding stage of each of production devices that are used by the workers in the subsequent step, and
the distribution adjustment circuitry adjusts the distribution such that the pre-step processed member yard individually provided for each of the production devices has a uniform use rate.

6. The process management device according to claim 5, wherein
the distribution adjustment circuitry lowers the distribution of intermediate products to a worker who performs work of the subsequent step associated with a pre-step processed member yard having a use rate higher than an average by a threshold or more among a plurality of the pre-step processed member yards.

7. The process management device according to claim 1, comprising
a display to display a result of adjustment by the distribution adjustment circuitry.

8. The process management device according to claim 7, wherein
the display displays, as the result of adjustment, the status of event occurrence in each step, a production ability of a production device installed in each step, a person in charge of work in each step, and an amount of conveyance of the intermediate products on each path for conveying the intermediate products.

9.-10. (canceled)

11. The process management device according to claim 1, comprising
work assignment changing circuitry to change, in response to detecting a state in which a production plan is not achievable, allocation of persons in charge of work to each step to an allocation that makes the production plan achievable or an allocation that maximizes production ability based on the personal data and the status of event occurrence.

12.-13. (canceled)

14. A process management device comprising:
status checking circuitry to check a status of event occurrence in a subsequent step, the status of event occurrence being related to an event that affects a production ability of the subsequent step, the subsequent step being a later one of adjacent two steps;
distribution adjustment circuitry to adjust, based on personal data and a result of checking by the status checking circuitry, distribution of intermediate products manufactured in a preceding step to workers who perform work of the subsequent step, the personal data indicating a production ability of each of the workers according to the status of event occurrence, the preceding step being an earlier one of the two adjacent steps;
calculation circuitry to repeatedly execute a process of virtually adjusting the distribution based on a state of each of processed member yards provided before and after each of the steps for placing the intermediate products, an amount of final product produced by a current time, and the personal data of workers in each of the steps, and calculate a total amount of final product to be produced by a designated time;
state observation circuitry to observe, as state variables, the status of event occurrence in each of the steps, the personal data of workers in each of the steps, a state of each of processed member yards, a result of adjustment of the distribution, and an amount of final product produced by a current time; and
learning circuitry to learn how to adjust the distribution according to a data set created based on the state variables and production plan information, wherein
the distribution adjustment circuitry adjusts the distribution based on a result of learning by the learning circuitry.

15. (canceled)

16. The process management device according to claim 14, wherein
the learning circuitry includes:
reward calculation circuitry to calculate a reward based on the total amount of final product to be produced by the designated time and a production plan associated with the designated time; and
function update circuitry to update a function for adjusting the distribution based on the reward.

17. The process management device according to claim 16, wherein
the reward calculation circuitry increases the reward in a case where a difference between the total amount of final product to be produced by the designated time and the production plan associated with the designated time is less than or equal to a threshold predetermined, and reduces the reward in a case where the difference is greater than the threshold.

18. A machine learning device that learns how a process management device adjusts, based on a status of event occurrence in a subsequent step and personal data, distribution of intermediate products manufactured in a preceding step to workers who perform work of the subsequent step, the status of event occurrence being related to an event that affects a production ability of the subsequent step, the subsequent step being a later one of adjacent two steps, the personal data indicating a production ability of each of the workers according to the status of event occurrence, the preceding step being an earlier one of the two adjacent steps, the machine learning device comprising:
calculation circuitry to repeatedly execute a process of virtually adjusting the distribution based on a state of each of processed member yards provided before and after each of the steps for placing the intermediate products, an amount of final product produced by a current time, and the personal data of workers in each of the steps, and calculate a total amount of final product to be produced by a designated time;
state observation circuitry to observe, as state variables, the status of event occurrence in each of the steps, the personal data of workers in each of the steps, a state of each of processed member yards, a result of adjustment of the distribution, and an amount of final product produced by a current time; and
learning circuitry to learn how to adjust the distribution according to a data set created based on the state variables and production plan information.
